(19) United States
(12) Patent Application Publication
(10) Pub. No.: US 2024/0397558 A1
(43) Pub. Date: Nov. 28, 2024

(54) DEVICE IN WIRELESS COMMUNICATION SYSTEM AND METHOD PERFORMED THEREBY

(71) Applicant: Samsung Electronics Co., Ltd., Suwon-si, Gyeonggi-do (KR)

(72) Inventors: Qi ZHANG, Beijing (CN); Feifei SUN, Beijing (CN)

(21) Appl. No.: 18/697,298

(22) PCT Filed: Sep. 30, 2022
(86) PCT No.: PCT/KR2022/014814

§ 371 Date: Mar. 29, 2024

(30) Foreign Application Priority Data
Sep. 30, 2021 (CN) 202111161558.4
Dec. 9, 2021 (CN) 202111499549.6

(51) Int. Cl. H04W 74/0833; H04W 76/38

(52) U.S. Cl. CPC H04W 74/0833; H04W 76/38

(57) ABSTRACT

The disclosure relates to a 5G or 6G communication system for supporting a higher data transmission rate. The present disclosure provides a user equipment (UE) in a wireless communication system and a method performed by the UE. The method includes: receiving a primary synchronization signal (PSS) and a secondary synchronization signal (SSS): receiving a physical broadcast channel block (PBCH), wherein the primary synchronization signal, the secondary synchronization signal and the PBCH constitute a synchronization signal and PBCH block (SSB).

### TECHNICAL FIELD

The present disclosure relates generally to a field of wireless communication, and more particularly, to a device in a wireless communication system and a method performed thereby.

### BACKGROUND ART

5G mobile communication technologies define broad frequency bands such that high transmission rates and new services are possible, and can be implemented not only in “Sub 6 GHz” bands such as 3.5 GHZ, but also in “Above 6 GHZ” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Technical Problem

The purpose of this application is to be able to solve at least one of the drawbacks of the prior art.

There is a need to define a method for SSB reception according to UE processing capability information, frequency band information and synchronization signal subcarrier spacing.

### Solution to Problem

The present invention provides a method for SSB reception according to UE processing capability information and/or frequency band information and/or synchronization signal subcarrier spacing.

According to an aspect of the present disclosure, there is provided a method performed by a user equipment (UE) in a wireless communication system, including: determining a first subcarrier spacing for a base station to transmit a synchronization signal and physical broadcast channel block (SSB) to the UE; determining whether a frequency domain bandwidth of the SSB corresponding to the first subcarrier spacing exceeds a maximum transmission bandwidth available for receiving the SSB under bandwidth capability of the UE; receiving the SSB by performing a first operation in case that the frequency domain bandwidth of the SSB corresponding to the first subcarrier spacing does not exceed the maximum transmission bandwidth available for receiving the SSB under the bandwidth capability of the UE; and receiving the SSB by performing a second operation in case that the frequency domain bandwidth of the SSB corresponding to the first subcarrier spacing exceeds the maximum transmission bandwidth available for receiving the SSB under the bandwidth capability of the UE, wherein the first operation is different from the second operation.

According to another aspect of the present disclosure, there is provided a method performed by a base station in a wireless communication system, including: determining a first subcarrier spacing for transmitting a synchronization signal and physical broadcast channel block (SSB) to a user equipment (UE); determining whether a frequency domain bandwidth of the SSB corresponding to the first subcarrier spacing exceeds a maximum transmission bandwidth available for receiving the SSB under bandwidth capability of the UE; transmitting the SSB by performing a first operation in case that the frequency domain bandwidth of the SSB corresponding to the first subcarrier spacing does not exceed the maximum transmission bandwidth available for receiving the SSB under the bandwidth capability of the UE; and transmitting the SSB by performing a second operation in case that the frequency domain bandwidth of the SSB corresponding to the first subcarrier spacing exceeds the maximum transmission bandwidth available for receiving the SSB under the bandwidth capability of the UE, wherein the first operation is different from the second operation.

According to yet another aspect of the present disclosure, there is provided a user equipment (UE) in a wireless communication network, including a transceiver configured to transmit and receive signals; and a controller configured to control the transceiver to perform the followings: determining a first subcarrier spacing for a base station to transmit a synchronization signal and physical broadcast channel block (SSB) to the UE; determining whether a frequency domain bandwidth of the SSB corresponding to the first subcarrier spacing exceeds a maximum transmission bandwidth available for receiving the SSB under bandwidth capability of the UE; receiving the SSB by performing a first operation in case that the frequency domain bandwidth of the SSB corresponding to the first subcarrier spacing does not exceed the maximum transmission bandwidth available for receiving the SSB under the bandwidth capability of the UE; and receiving the SSB by performing a second operation in case that the frequency domain bandwidth of the SSB corresponding to the first subcarrier spacing exceeds the maximum transmission bandwidth available for receiving the SSB under the bandwidth capability of the UE, wherein the first operation is different from the second operation.

According to yet another aspect of the present disclosure, there is provided a base station in a wireless communication network, including a transceiver configured to transmit and receive signals; and a controller configured to control the transceiver to perform the followings: determining a first subcarrier spacing for transmitting a synchronization signal and physical broadcast channel block (SSB) to a user equipment (UE); determining whether a frequency domain bandwidth of the SSB corresponding to the first subcarrier spacing exceeds a maximum transmission bandwidth available for receiving the SSB under bandwidth capability of the UE; transmitting the SSB by performing a first operation in case that the frequency domain bandwidth of the SSB corresponding to the first subcarrier spacing does not exceed the maximum transmission bandwidth available for receiving the SSB under the bandwidth capability of the UE; and transmitting the SSB by performing a second operation in case that the frequency domain bandwidth of the SSB corresponding to the first subcarrier spacing exceeds the maximum transmission bandwidth available for receiving the SSB under the bandwidth capability of the UE, wherein the first operation is different from the second operation.

According to yet another aspect of the present disclosure, there is provided a method performed by a user equipment (UE) in a wireless communication system, including: receiving a primary synchronization signal (PSS) and a secondary synchronization signal (SSS); receiving a physical broadcast channel block (PBCH); wherein the primary synchronization signal, the secondary synchronization signal and the PBCH constitute a synchronization signal and PBCH block (SSB).

According to yet another aspect of the present disclosure, there is provided a method performed by a base station in a wireless communication system, including: transmitting a primary synchronization signal (PSS) and a secondary synchronization signal (SSS); transmitting a physical broadcast channel block (PBCH), wherein the primary synchronization signal, the secondary synchronization signal and the PBCH constitute a synchronization signal and PBCH block (SSB).

According to yet another aspect of the present disclosure, there is provided a user equipment (UE) in a wireless communication network, including a transceiver configured to transmit and receive signals; and a controller configured to control the transceiver to perform: receiving a primary synchronization signal (PSS) and a secondary synchronization signal (SSS); receiving a physical broadcast channel block (PBCH); wherein the primary synchronization signal, the secondary synchronization signal and the PBCH constitute a synchronization signal and PBCH block (SSB).

According to yet another aspect of the present disclosure, there is provided a base station in a wireless communication network, including a transceiver configured to transmit and receive signals; and a controller configured to control the transceiver to perform: transmitting a primary synchronization signal (PSS) and a secondary synchronization signal (SSS); transmitting a physical broadcast channel block (PBCH), wherein the primary synchronization signal, the secondary synchronization signal and the PBCH constitute a synchronization signal and PBCH block (SSB).

### Advantageous Effects of Invention

Embodiments of the present disclosure provides methods and apparatus for determining SSB receiving operation based on UE processing capability and subcarrier spacing. Therefore, SSB reception can be performed more efficiently.

### BRIEF DESCRIPTION OF DRAWINGS

The above and other aspects, features and advantages of certain embodiments of the present disclosure will be more apparent from the following description taken in conjunction with the accompanying drawings, in which:

FIG. 1 illustrates an example wireless network according to various embodiments of the present disclosure;

FIG. 2A illustrates an example wireless transmission path according to the present disclosure;

FIG. 2B illustrates an example wireless reception path according to the present disclosure;

FIG. 3A illustrates an example user equipment (UE) according to the present disclosure;

FIG. 3B illustrates an example gNB according to the present disclosure;

FIG. 4A illustrates an example SSB according to the present disclosure;

FIG. 4B illustrates a method performed by a UE in a wireless communication system according to an embodiment of the present disclosure;

FIG. 4C illustrates a method performed by a base station (BS) in a wireless communication system according to an embodiment of the present disclosure.

FIG. 5 illustrates a method performed by a UE in a wireless communication system according to an embodiment of the present disclosure;

FIG. 6 illustrates a method performed by a base station (BS) in a wireless communication system according to an embodiment of the present disclosure;

FIG. 7 illustrates a method performed by a UE in a wireless communication system according to an embodiment of the present disclosure;

FIG. 8 illustrates a method performed by a UE in a wireless communication system according to an embodiment of the present disclosure;

FIG. 9 illustrates a method performed by a UE in a wireless communication system according to an embodiment of the present disclosure;

FIG. 10 illustrates a PBCH data transmission processing flow according to an embodiment of the present disclosure;

FIG. 11 illustrates a method performed by a UE in a wireless communication system according to an embodiment of the present disclosure;

FIG. 12 illustrates a frequency band of a UE according to an embodiment of the present disclosure;

FIG. 13 illustrates a method performed by a UE in a wireless communication system according to an embodiment of the present disclosure;

FIG. 14 illustrates a radio-frequency central frequency offset of a UE according to an embodiment of the present disclosure;

FIG. 15 illustrates a method performed by a UE in a wireless communication system according to an embodiment of the present disclosure;

FIG. 16 illustrates a time domain symbol position of a SSB according to an embodiment of the present disclosure;

FIG. 17 illustrates a time domain symbol position of a SSB according to an embodiment of the present disclosure;

FIG. 18 illustrates a frequency band of a UE according to an embodiment of the present disclosure;

FIG. 19 illustrates a time domain symbol position of an auxiliary PBCH demodulation signal according to the embodiment of the present disclosure;

FIG. 20 illustrates a time domain symbol position of an auxiliary PBCH demodulation signal according to the embodiment of the present disclosure;

FIG. 21 illustrates a time domain symbol position of an auxiliary PBCH de-modulation signal according to the embodiment of the present disclosure;

FIG. 22 illustrates a method performed by a UE in a wireless communication system according to an embodiment of the present disclosure;

FIG. 23 illustrates a frequency band of a UE according to an embodiment of the present disclosure;

FIG. 24 illustrates a time domain symbol position of an auxiliary PBCH demodulation signal according to the embodiment of the present disclosure;

FIG. 25 illustrates a time domain symbol position of an auxiliary PBCH demodulation signal according to the embodiment of the present disclosure;

FIG. 26 illustrates a time domain symbol position of an auxiliary PBCH demodulation signal according to the embodiment of the present disclosure;

FIG. 27 illustrates a method performed by a UE in a wireless communication system according to an embodiment of the present disclosure;

FIG. 28 illustrates a block diagram of the structure of a UE according to an embodiment of the present disclosure; and

FIG. 29 illustrates a block diagram of the structure of a base station according to an embodiment of the present disclosure.

### MODE FOR THE INVENTION

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

Technical schemes of embodiments of the present application may be applied to various communication systems, such as Global System for Mobile Communications (GSM) system, Code Division Multiple Access (CDMA) system, Wideband Code Division Multiple Access (WCDMA) system, General Packet Radio Service (GPRS), Long Term Evolution (LTE) system, LTE Frequency Division Duplex (FDD) system, LTE Time Division Duplex (TDD) system, Universal Mobile Telecommunications System (UMTS), Worldwide Interoperability for Microwave Access (WiMAX) communication system, 5th Generation (5G) system or New Radio (NR), etc. In addition, the technical schemes of embodiments of the present application may be applied to future-oriented communication technologies.

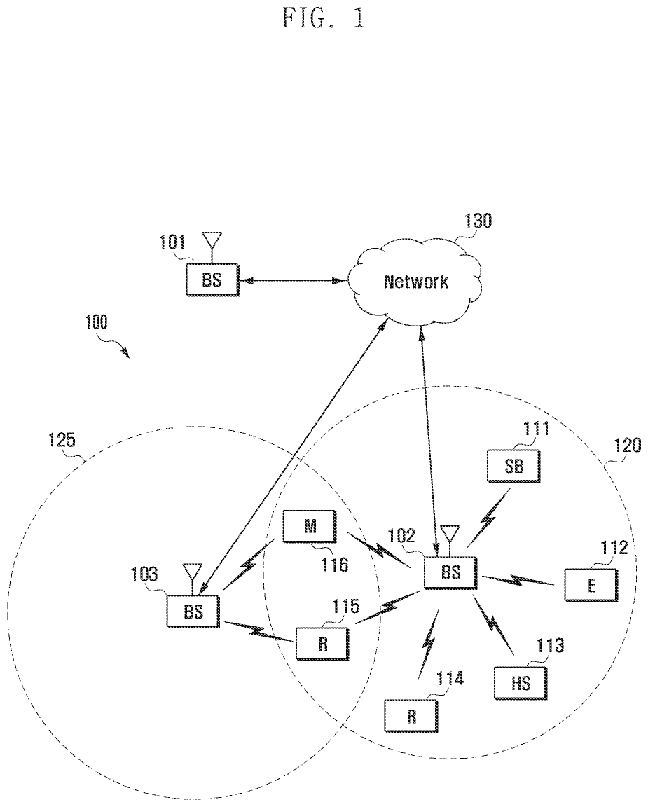

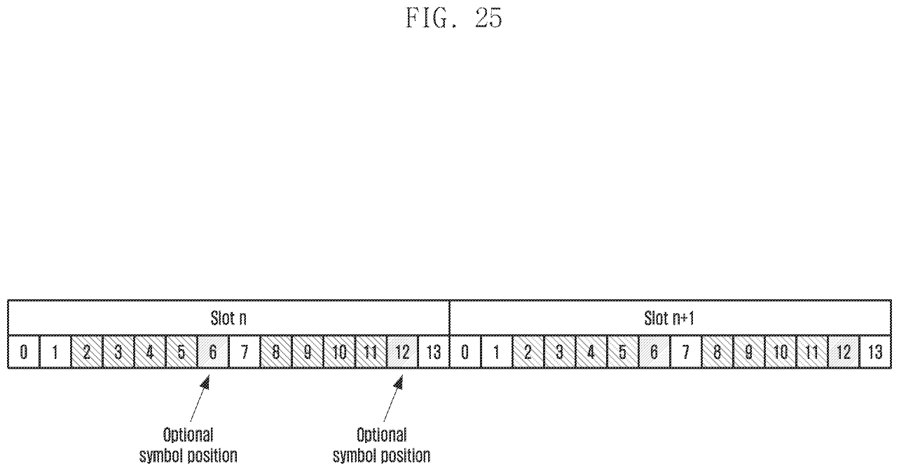

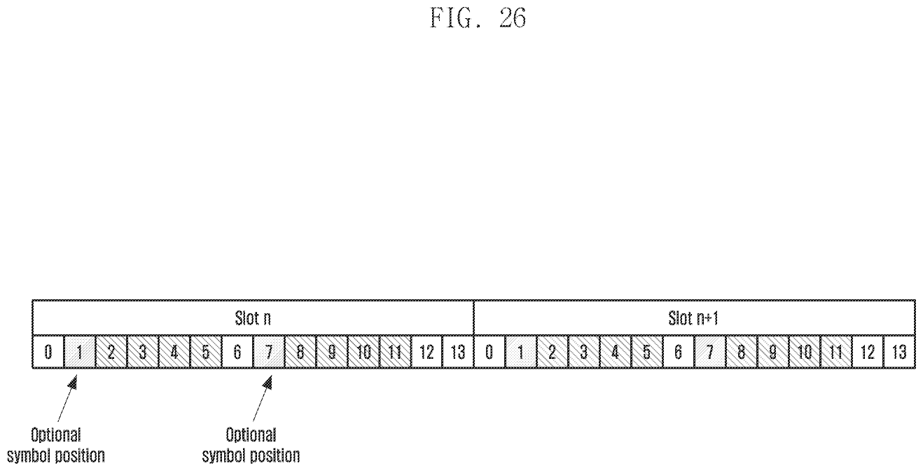

FIGS. 1 to 27 discussed below and various embodiments used to describe the principles of the present disclosure in this patent document are for illustration only, and should not be construed as limiting the scope of the present disclosure in any way. Those skilled in the art will understand that the principles of the present disclosure may be implemented in any appropriately arranged system or device. FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

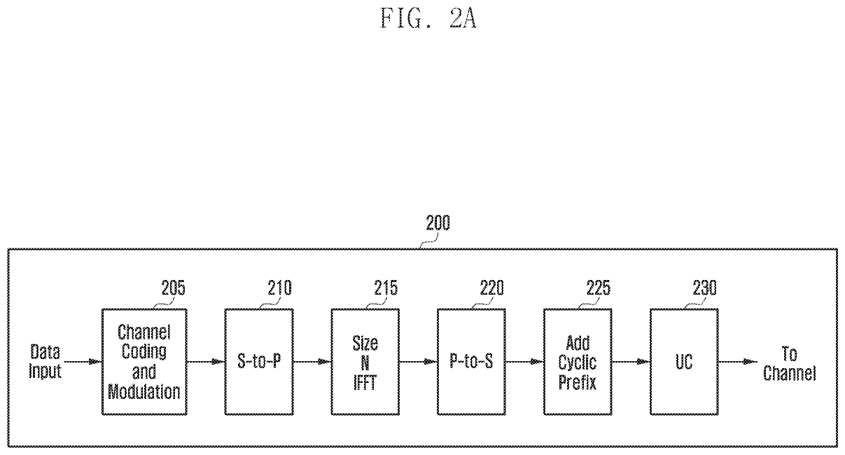

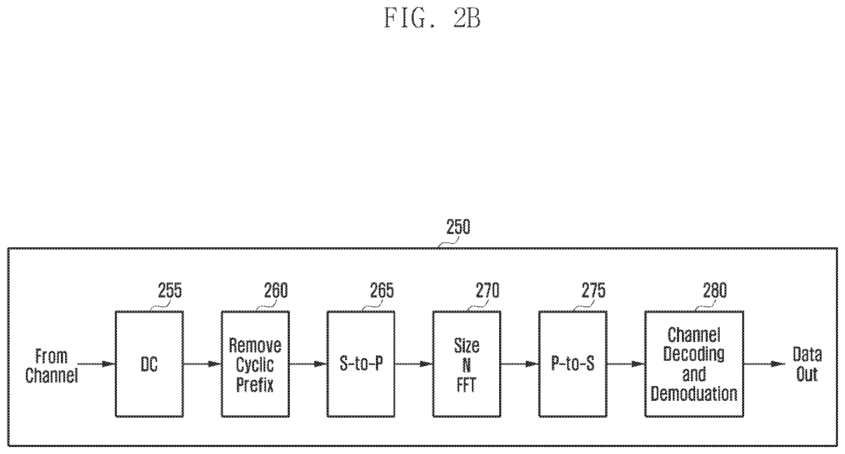

FIGS. 2A and 2B illustrate example wireless transmission and reception paths according to the present disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

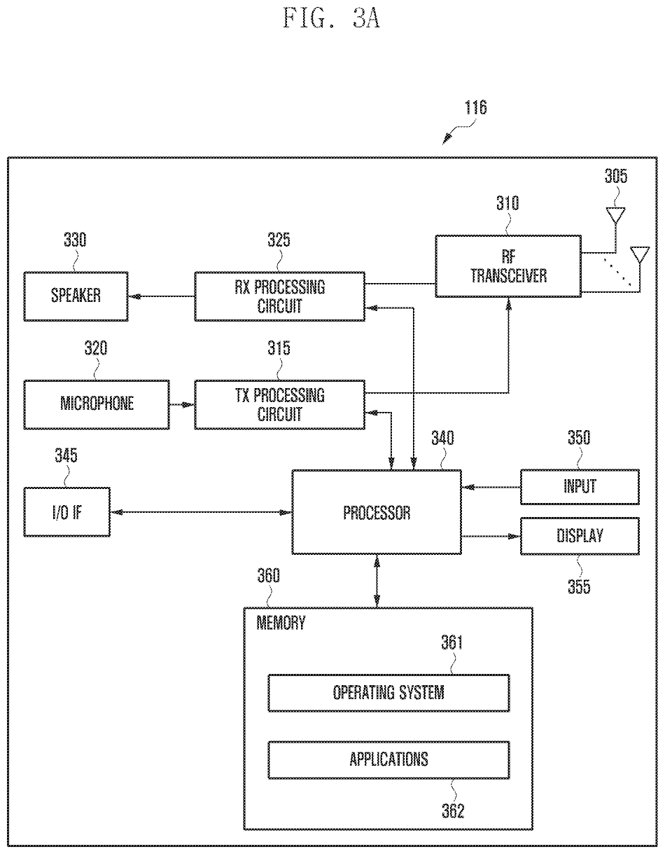

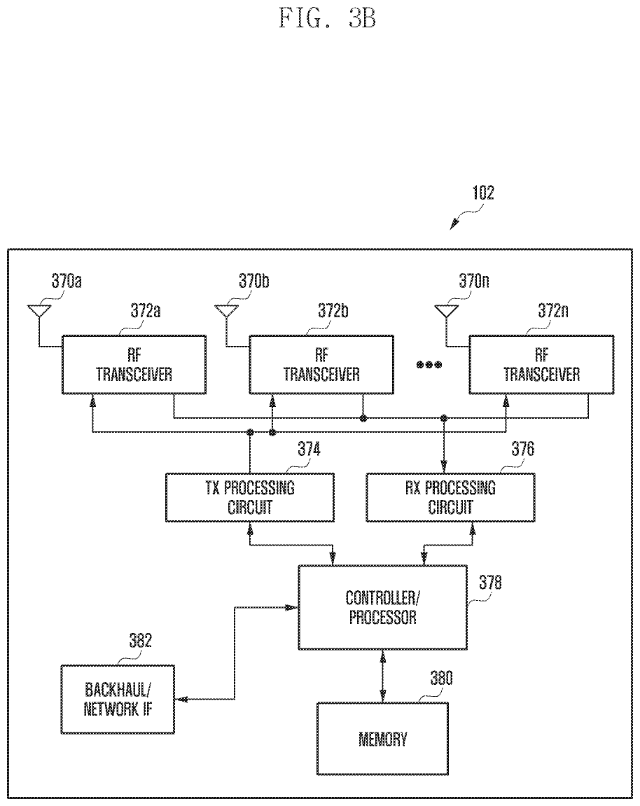

FIG. 3A illustrates an example UE 116 according to the present disclosure. The embodiment of UE 116 shown in FIG. 3A is for illustration only, and UEs 111-115 of FIG. 1 can have the same or similar configuration. However, a UE has various configurations, and FIG. 3A does not limit the scope of the present disclosure to any specific implementation of the UE.

UE 116 includes an antenna 305, a radio-frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to the present disclosure. The embodiment of gNB 102 shown in FIG. 3B is for illustration only, and other gNBs of FIG. 1 can have the same or similar configuration. However, a gNB has various configurations, and FIG. 3B does not limit the scope of the present disclosure to any specific implementation of a gNB. It should be noted that gNB 101 and gNB 103 can include the same or similar structures as gNB 102.

As shown in FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and upconvert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

The text and drawings are provided as examples only to help readers understand the present disclosure. They are not intended and should not be interpreted as limiting the scope of the present disclosure in any way. Although certain embodiments and examples have been provided, based on the content disclosed herein, it is obvious to those skilled in the art that modifications to the illustrated embodiments and examples can be made without departing from the scope of the present disclosure.

UE needs to perform downlink synchronization before initial random access to an NR system, receive necessary configuration of SIB1 (System Information Block #1), and then perform initial random access according to the received SIB1 parameters. The NR system designs a Primary Synchronization Signal (PSS) and a Secondary Synchronization Signal (SSS) for downlink synchronization, and transmits a MIB (Master Information Block) in a Physical Broadcast Channel (PBCH).

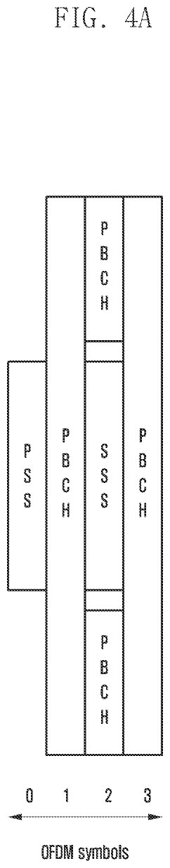

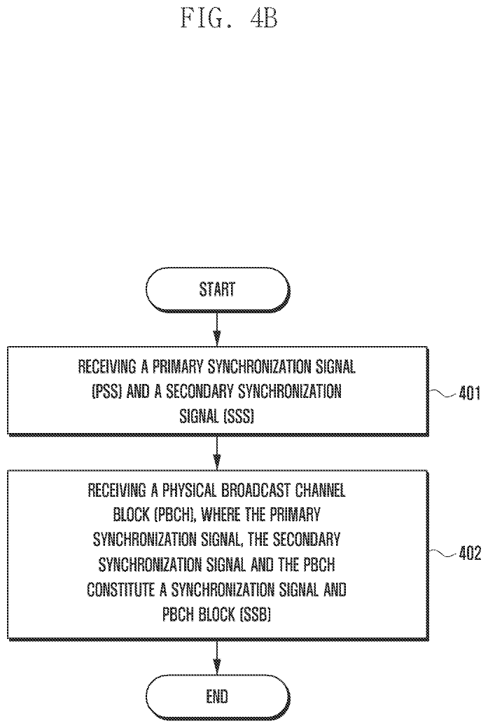

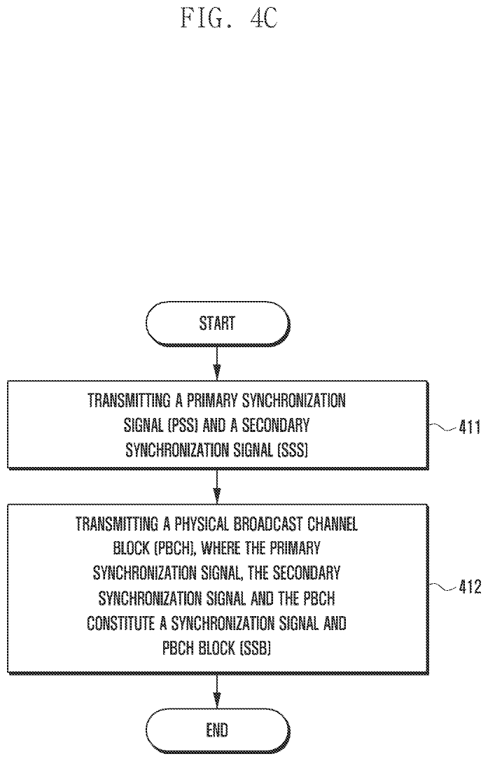

The synchronization signals PSS, SSS and PBCH channels together constitute a SSB (Synchronization Signal and PBCH block). For a SSB, the PSS and SSS occupy 1 symbol and 127 subcarriers in time-frequency domain, while the PBCH occupies 3 symbols and 240 subcarriers in time-frequency domain, as shown in FIG. 4A.

The protocol specifies a Global Synchronization Channel Number (GSCN) supported by a frequency band, which is used for rapid downlink synchronization at the frequency band location. A subcarrier with a subcarrier index of 120 in a SSB should be aligned with a synchronization raster.

The 5G (the fifth-generation) system is optimized and designed for enhanced Mobile Broadband (eMBB), enhanced Ultra-Reliable Low Latency Communications (eURLLC), and enhanced Machine Type Communication (eMTC), etc. In order to better support machine type communication, the 3GPP (3rd Generation Partnership Project) defines a reduced capability UE (redcap UE) in the protocol. Compared with other UEs, this type of UE has lower support capability, such as fewer supported antennas and smaller supported bandwidth, etc., thus having lower energy consumption and longer battery life.

Compared with an eMBB terminal with the lowest requirement of NR, a Redcap UE has a smaller bandwidth. For example, bandwidth capability of 5 MHz may be introduced in R18, so SSB reception beyond the bandwidth capability under limited bandwidth is a problem that needs to be solved. In addition, R18 needs to support a frequency band smaller than 5 MHz for some railway scenarios, such as a Future Railway Mobile Communication System (FRMCS), PPDU, smart utilities, etc. In these scenarios, it is also a problem needing to be solved that a base station transmits a SSB in a frequency band smaller than the SSB bandwidth. For example, in case of Railway Mobile Radio (RMR)-900 band, n8, n26 and n28, when a supported bandwidth is between 3 MHz and 5 MHz, a PBCH channel bandwidth with a subcarrier spacing of 15 KHz is 3.6 MHz, which exceeds the bandwidth that the base station may support. In this case, it is necessary to design a SSB transmission method so that the SSB may be transmitted within an effective bandwidth of the system, and the terminal may receive the SSB signal on a specific frequency band.

The protocol designed some optimization points with respect to the characteristics of small bandwidth of the Redcap terminal. At present, it is determined that the Redcap terminal may support configuration of a separate initial UL BWP. If the separate initial UL BWP is configured, the terminal needs to perform random access according to the configuration after detecting the SSB and receiving the SIB1. At the same time, whether configuration of a separate initial DL BWP is supported for downlink accordingly is also discussed in the protocol.

The following problems may exist after adding the separate initial DL BWP and separate initial UL BWP.

### Problem 1: Search Space Configuration for Paging, System Information in the Separate Initial DL BWP

The separate initial DL BWP may or may not contain CORESET #0 (control resource set ID 0) in frequency domain. When the separate initial DL BWP contains CORESET #0, a common search space for paging, system information (SI) and random access (RA) in the separate initial DL BWP configuration may be configured with CORESET #0 or a subset thereof. When the separate initial DL BWP does not contain CORESET #0, a common search space for random access (RA) in the separate initial DL BWP configuration may be configured as locations other than CORESET #0 RBs, while a common search space for paging and system information (SI) is CORESET #0 by default. In this way, it is ensured that the redcap UE can normally receive paging and system information in an idle state (RRC_IDLE) and an inactive state (RRC_INACTIVE).

Search space configuration may be defined in the protocol, and configuration restrictions or predefined condition may be added for paging and system information.

The following configurations are supported for the separate initial DL BWP:
search space for SIB1 (searchSpaceSIB1), searchSpacedId OPTIONAL:
in case of separate initial DL BWP, this value is 0
and/or
the following configurations are supported for the separate initial DL BWP:
search space for other system information (searchSpaceOtherSystemInformation): SearchSpaceId OPTIONAL:
in case of separate initial DL BWP, if this value is not configured, monitoring occasions of PDCCHs for receiving system information in a system information window are the same as that of PDCCHs for SIB1. And/or,
in case of separate initial DL BWP and this value is configured, a system information is acquired according to the UE type:
when the UE is a redcap terminal, the system information is acquired according to the search space configuration in the separate initial DL BWP, and/or
when the UE is a redcap terminal, the system information is acquired according to the search space configurations in the separate initial DL BWP and the initial DL BWP.
and/or
the following configurations are supported for the separate initial DL BWP:
search space for paging (pagingSearchSpace): SearchSpaceId OPTIONAL

In case of separate initial DL BWP, if this value is not configured, the redcap UE receives paging according to the search space configuration for paging in the initial DL BWP.

And/or
in case of separate initial DL BWP, if this value is configured, the redcap UE receives paging according to the search space configuration for paging in the separate initial DL BWP.

### Problem 2: Subcarrier Spacing and Cyclic Prefix Length Configuration of the Separate Initial DL BWP

When there is RB overlapping between the separate initial DL BWP and the initial DL BWP, if they are configured with different subcarrier spacings, a frequency domain guardband needs to be reserved therebetween, thus resulting in spectrum efficiency degradation. Meanwhile, when the separate initial DL BWP contains RBs of CORESET #0, the separate initial DL BWP may reuse the search space for system information when CORESET #0 is configured to a connected state (RRC_CONNECTED).

Therefore, it may be predefined in the protocol that:

The subcarrier spacing of the separate initial DL BWP should be consistent with that of the initial DL BWP.
and/or
the subcarrier spacing of the separate initial DL BWP should be consistent with that of the initial DL BWP and its corresponding SSB.
and/or
when the separate initial DL BWP contains all RBs of CORESET #0, the subcarrier spacing of the separate initial DL BWP should be consistent with that of the initial DL BWP.
and/or
in the separate initial DL BWP, the CORESET number of the search space for SIB1 (Type0-PDCCH CSS) is 0, and the number of the search space is 0.
and/or
when the separate initial DL BWP contains all RBs of CORESET #0, and its subcarrier spacing is the same as that of the initial DL BWP, the CORESET number of the search space for SIB1 (Type0-PDCCH CSS) is 0, and the number of the search space is 0.
and/or
when the separate initial DL BWP contains all RBs of CORESET #0, and its subcarrier spacing and cyclic prefix length are the same as those of the initial DL BWP, the CORESET number of the search space for SIB1 (Type0-PDCCH CSS) is 0, and the number of the search space is 0.
   Problem 3: Compatibility of the Separate Initial DL BWP with Existing Protocols

The following adaptations are made for relevant processes of a bwp-Inactivity Timer (the contents marked in yellow are newly added):
1> if a default downlink BWP (defaultDownlinkBWP-Id) is not configured, and the active DL BWP is not the initialDownlinkBWP, and the active DL BWP is not the BWP indicated by the dormant BWP (dormantBWP-Id),
2> if athe bwp-Inactivity Timer associated with the active DL BWP expires,
3> if the defaultDownlinkBWP-Id is configured,
4> perform BWP switching to a BWP indicated by this Id
3> else
4> if the UE is a redcap UE and the separate initial DL BWP is configured
5> perform BWP switching to the separate initial DL BWP
4> otherwise
5> perform BWP switching to the initiaDownlinkBWP
1> if a PDCCH for BWP switching is received by the UE, and the MAC entity switches the active DL BWP
2> if the defaultDownlinkBWP-Id is not configured, and the MAC entity switches to the DL BWP which is not indicated by the initialDownlinkBWP or by the separate initialDownlinkBWP, and not indicated by as the dormantBWP-Id.
3> start or restart the bwp-InactivityTimer associated with the active DL BWP

In an initial access to a serving cell, after selecting a carrier for random access, the MAC entity should make the following judgements on the selected carrier of the serving cell
1> if PRACH occasions are not configured for the active UL BWP\
2> if a separate initial UL BWP is configured for the redcap UE
3> switch to the separate initial UL BWP
2> otherwise
3> switch to the initial uplink BWP (initialUplinkBWP)
2> if the serving cell is a Spcell:
3> if separate initial DL BWP is configured for the redcap UE
4> switch to the separate initial DL BWP
3> else
4> switch to the initial downlink BWP (initialDownlinkBWP)
1> else
2> if the serving cell is a Spcell
3> if the active DL BWP does not have the same bwp-Id as the active UL BWP
4> switch the active DL BWP to the BWP with the same bwp-Id as the active UL BWP

Hereinafter, a bandwidth capability of 5 MHz (i.e., supporting a maximum bandwidth of 5 MHz) is taken as an example of the bandwidth capability of a redcap UE. However, the present disclosure is not limited thereto, and the maximum bandwidth that the redcap UE can support may be smaller than 5 MHz or greater than 5 MHz.

The bandwidth capability of the UE includes a maximum transmission bandwidth of the UE and a guardband that needs to be reserved, which is specified in the protocol. For example, the protocol specifies the guardband and the maximum transmission band by specifying a number of physical resource blocks (PRBs) for one SSB, a subcarrier spacing and a number of physical resource blocks, as shown in Table 1 below.

TABLE 1

| | 5 MHz | 10 MHz | 15 MHZ | 20 MHz |
|---|---|---|---|---|
| SCS (kHz) | N_{RB} | N_{RB} | N_{RB} | N_{RB} |
| 15 | 25 | 52 | 79 | 106 |
| 30 | 11 | 24 | 38 | 51 |
| 60 | N/A | 11 | 18 | 24 |

Table 1: number of physical resource blocks N_{RB} configured based on bandwidth capability and subcarrier spacing

Specifically, for example, for a redcap UE with bandwidth capability of 5 MHz, the maximum transmission bandwidth that can be detected at a subcarrier spacing of 30 KHz is 11*12*30 KHz=3.96 MHz, and correspondingly, the bandwidth of the guardband=5 MHz-3.96 MHz=1.04 MHz.

For a SSB, the number of subcarriers of PSS/SSS is 127, and the frequency domain bandwidth is 1.905 MHz when the subcarrier spacing is 15 KHz, and 3.81 MHz when the subcarrier spacing is 30 KHz, which are smaller than 3.96 MHz. When the subcarrier spacing is 15 KHz and 30 KHz, the PSS/SSS bandwidth is within the bandwidth capability of the redcap UE, that is, the PSS/SSS bandwidth is within the maximum transmission bandwidth under the bandwidth capability of the redcap UE, which means that the UE may receive a synchronization signal according to the existing methods.

For a SSB, the number of subcarriers of the PBCH (including DMRS) is 240 on symbol 1 and symbol 3, and the number of subcarriers of the PBCH is 48+48 on symbol 2.

When the subcarrier spacing is 15 KHz, the frequency domain bandwidth of the SSB is:
PSS/SSS: 127*15 KHz=1.905 MHz
PBCH: 240*15 KHz=3.6 MHz

When the subcarrier spacing is 30 KHz, the frequency domain bandwidth of the SSB is:
PSS/SSS: 127*30 KHz=3.81 MHz
PBCH: 240*30 KHz=7.2 MHZ

When the subcarrier spacing is 15 KHz, for a redcap UE with a maximum bandwidth capability of 5 MHz, the SSB (PBCH) frequency domain bandwidth of 3.6 MHz does not exceed the bandwidth capability that the UE can process, specifically, it does not exceed the maximum transmission bandwidth of 3.96 MHz. When the subcarrier spacing is 30 KHz, for the redcap UE with a maximum bandwidth capability of 5 MHZ, the SSB (PBCH) frequency domain bandwidth of 7.2 MHz exceeds the bandwidth capability that the UE can process, specifically, it exceeds the maximum transmission bandwidth of 3.96 MHz. How to receive the SSB (PBCH) when the frequency domain bandwidth of the SSB (PBCH) exceeds the bandwidth capability of the UE is a problem to be solved.

Hereinafter, 5 MHz is taken as an example of bandwidth capability of the redcap UE, 15 KHz is taken as an example of subcarrier spacing (also referred to as “first subcarrier spacing”) that makes the frequency domain bandwidth of the SSB (PBCH) not exceed the bandwidth capability of the redcap UE, and 30 KHz is taken as an example of subcarrier spacing (also referred to as “second subcarrier spacing”) that makes the frequency domain bandwidth of the SSB (PBCH) exceed the bandwidth capability of the redcap UE, to describe various methods and devices of the present disclosure. However, the bandwidth capability of the redcap UE, the first subcarrier spacing, and the second subcarrier spacing are not limited to the foregoing examples.

FIG. 4B illustrates a method performed by a user equipment (UE) in a wireless communication system according to an embodiment of the present disclosure. At step 401, the UE receives a primary synchronization signal (PSS) and a secondary synchronization signal (SSS). At step 402, the UE receives a physical broadcast channel block (PBCH), where the primary synchronization signal, the secondary synchronization signal and the PBCH constitute a synchronization signal and PBCH block (SSB).

FIG. 4C illustrates a method performed by a base station in a wireless communication system according to an embodiment of the present disclosure. At step 411, the base station transmits a primary synchronization signal (PSS) and a secondary synchronization signal (SSS). At step 412, the base station transmits a physical broadcast channel block (PBCH), where the primary synchronization signal, the secondary synchronization signal and the PBCH constitute a synchronization signal and PBCH block (SSB).

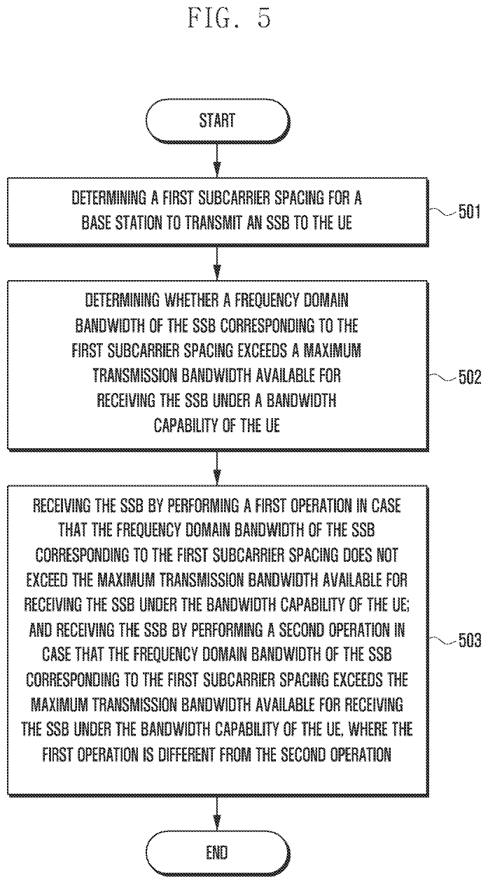

FIG. 5 illustrates a method performed by a user equipment (UE) in a wireless communication system according to an embodiment of the present disclosure. At step 501, the UE may determine a first subcarrier spacing for a base station to transmit a SSB to the UE. For example, the UE may determine a frequency band for the base station (BS) to transmit the SSB to the UE; determine one or more subcarrier spacings corresponding to the frequency band based on a predetermined rule; and determine a second subcarrier spacing as the first subcarrier spacing in case that the determined one or more subcarrier spacings only include the second subcarrier spacing (e.g., 15 KHz); determine a third subcarrier spacing as the first subcarrier spacing in case that the determined subcarrier spacings only include the third subcarrier spacing (e.g., 30 KHz); determine the second subcarrier spacing as the first subcarrier spacing in case that the determined subcarrier spacings include the second subcarrier spacing and the third subcarrier spacing, where the second subcarrier spacing is smaller than the third subcarrier spacing, and a frequency domain bandwidth of the SSB corresponding to the second subcarrier spacing (e.g., 15 KHz) does not exceed a maximum transmission bandwidth available for receiving the SSB under bandwidth capability (e.g., 5 MHZ) of the UE, while a frequency domain bandwidth of the SSB corresponding to the third subcarrier spacing (e.g., 30 KHz) exceeds the maximum transmission bandwidth available for receiving the SSB under the bandwidth capability (e.g., 5 MHZ) of the UE. The UE may determine a subcarrier spacing corresponding to a frequency band in which the UE is to receive the SSB from the base station (BS). For example, the UE may determine the subcarrier spacing corresponding to the frequency band in which the SSB is to be received from the base station based on specification of the protocol, as shown in Table 2. For example, when the frequency band in which the SSB is to be received from the base station is n51, the subcarrier spacing corresponding to n51 is 15 KHz. When the frequency band in which the SSB is to be received from the base station is n77, the subcarrier spacing corresponding to n77 is 30 KHz. When the frequency band in which the SSB is to be received from the base station is n90, the subcarrier spacings corresponding to n90 are 15 KHz and 30 KHz. However, methods for the UE to determine the subcarrier spacing corresponding to the frequency band in which the SSB is to be received from the base station are not limited thereto. For another example, the UE may determine the first subcarrier spacing for the base station to transmit the SSB to the UE through blind detection. It is specified by the protocol that for FRI subcarrier spacings for SSB can be 15 KHz and 30 KHz, and the UE may skip the frequency band information and use these two subcarrier spacings to perform SSB searching respectively. For example, it is assumed that SSB subcarrier spacing of 15 KHz is used for SSB reception first, and if the reception fails, SSB subcarrier spacing of 30 KHz is used for the reception.

At step 502, the UE may determine whether a frequency domain bandwidth of the SSB corresponding to the first subcarrier spacing exceeds a maximum transmission bandwidth available for receiving the SSB under bandwidth capability of the UE. At step 503, the UE may receive the SSB by performing a first operation in case that the frequency domain bandwidth of the SSB corresponding to the first subcarrier spacing does not exceed the maximum transmission bandwidth available for receiving the SSB under the bandwidth capability of the UE; and the UE may receive the SSB by performing a second operation in case that the frequency domain bandwidth of the SSB corresponding to the first subcarrier spacing exceeds the maximum transmission bandwidth available for receiving the SSB under the bandwidth capability of the UE, where the first operation is different from the second operation. When the UE receives the SSB based on the first subcarrier spacing, the UE may perform SSB reception according to UE processing capability information and/or frequency band information and/or synchronization signal subcarrier spacing. The UE may adjust the central frequency point to search for a primary synchronization signal, and may determine and receive a secondary synchronization signal according to the time-frequency domain location of the primary synchronization signal. The UE may receive the primary and secondary synchronization signals to receive and demodulate a broadcast signal. The method described referring FIG. 5 can ensure that the SSB bandwidth is within the processing bandwidth of the terminal, reduce the complexity of UE blind detection, and increase the success rate of PBCH demodulation, thus increasing the success rate of terminal access to the network.

TABLE 2

| NR | | | |
|---|---|---|---|
| operating | SS Block | SS Block | Range of GSCN [symbol] |
| band [symbol] | SCS [symbol] | pattern¹ [symbol] | (First - <Step size> - Last) [symbol] |
| n1 [symbol] | 15 KHz [symbol] | Case A [symbol] | 5279 - <1> - 5419 [symbol] |
| n2 [symbol] | 15 KHz [symbol] | Case A [symbol] | 4829 - <1> - 4969 [symbol] |
| n3 [symbol] | 15 KHz [symbol] | Case A [symbol] | 4517 - <1> - 4693 [symbol] |
| n5 [symbol] | 15 KHz [symbol] | Case A [symbol] | 2177 - <1> - 2230 [symbol] |
| | 30 KHz [symbol] | Case B [symbol] | 2183 - <1> - 2224 [symbol] |
| n7 [symbol] | 15 KHz [symbol] | Case A [symbol] | 6554 - <1> - 6718 [symbol] |
| n8 [symbol] | 15 KHz [symbol] | Case A [symbol] | 2318 - <1> - 2395 [symbol] |
| n12 [symbol] | 15 KHz [symbol] | Case A [symbol] | 1828 - <1> - 1858 [symbol] |
| n14 [symbol] | 15 KHz [symbol] | Case A [symbol] | 1901 - <1> - 1915 [symbol] |
| n18 [symbol] | 15 KHz [symbol] | Case A [symbol] | 2156 - <1> - 2182 [symbol] |
| n20 [symbol] | 15 KHz [symbol] | Case A [symbol] | 1982 - <1> - 2047 [symbol] |
| n25 [symbol] | 15 KHz [symbol] | Case A [symbol] | 4829 - <1> - 4981 [symbol] |
| n26 [symbol] | 15 KHz [symbol] | Case A [symbol] | 2153 - <1> - 2230 [symbol] |
| n28 [symbol] | 15 KHz [symbol] | Case A [symbol] | 1901 - <1> - 2002 [symbol] |
| n29 [symbol] | 15 KHz [symbol] | Case A [symbol] | 1798 - <1> - 1813 [symbol] |
| n30 [symbol] | 15 KHz [symbol] | Case A [symbol] | 5879 - <1> - 5893 [symbol] |
| n34 [symbol] | 15 KHz [symbol] | Case A [symbol] | NOTE 5 [symbol] |
| [symbol] | 30 KHz [symbol] | Case C [symbol] | 5036 - <1> - 5050 [symbol] |
| n38 [symbol] | 15 KHz [symbol] | Case A [symbol] | NOTE 2 [symbol] |
| [symbol] | 30 KHz [symbol] | Case C [symbol] | 6437 - <1> - 6538 [symbol] |
| n39 [symbol] | 15 KHz [symbol] | Case A [symbol] | NOTE 6 [symbol] |
| [symbol] | 30 KHz [symbol] | Case C [symbol] | 4712 - <1> - 4789 [symbol] |
| n40 [symbol] | 30 KHz [symbol] | Case C [symbol] | 5762 - <1> - 5989 [symbol] |
| n41 [symbol] | 15 KHz [symbol] | Case A [symbol] | 6246 - <3> - 6717 [symbol] |
| [symbol] | 30 KHz [symbol] | Case C [symbol] | 6252 - <3> - 6714 [symbol] |
| n46 [symbol] | 30 KHz [symbol] | Case A [symbol] | 8993 - <1> - 9530 [symbol] |
| n48 [symbol] | 30 KHz [symbol] | Case C [symbol] | 7884 - <1> - 7982 [symbol] |
| n50 [symbol] | 30 KHz [symbol] | Case C [symbol] | 3590 - <1> - 3781 [symbol] |
| n51 [symbol] | 15 KHz [symbol] | Case C [symbol] | 3572 - <1> - 3574 [symbol] |
| n53 [symbol] | 15 KHz [symbol] | Case A [symbol] | 6215 - <1> - 6232 [symbol] |
| n65 [symbol] | 15 KHz [symbol] | Case A [symbol] | 5279 - <1> - 5494 [symbol] |
| n66 [symbol] | 15 KHz [symbol] | Case A [symbol] | 5279 - <1> - 5494 [symbol] |
| | 30 KHz [symbol] | Case B [symbol] | 5285 - <1> - 5488 [symbol] |
| n70 [symbol] | 15 KHz [symbol] | Case A [symbol] | 4993 - <1> - 5044 [symbol] |
| n71 [symbol] | 15 KHz [symbol] | Case A [symbol] | 1547 - <1> - 1624 [symbol] |
| n74 [symbol] | 15 KHz [symbol] | Case A [symbol] | 3692 - <1> - 3790 [symbol] |
| n75 [symbol] | 15 KHz [symbol] | Case A [symbol] | 3584 - <1> - 3787 [symbol] |
| n76 [symbol] | 15 KHz [symbol] | Case A [symbol] | 3572 - <1> - 3574 [symbol] |
| n77 [symbol] | 30 KHz [symbol] | Case C [symbol] | 7711 - <1> - 8329 [symbol] |
| n78 [symbol] | 30 KHz [symbol] | Case C [symbol] | 7711 - <1> - 8051 [symbol] |
| n79 [symbol] | 30 KHz [symbol] | Case C [symbol] | 8480 - <1> - 8880 [symbol] |
| n90 [symbol] | 15 KHz [symbol] | Case A [symbol] | 6246 - <1> - 6717 [symbol] |
| | 30 KHz [symbol] | Case C [symbol] | 6252 - <1> - 6714 [symbol] |
| n91 [symbol] | 15 KHz [symbol] | Case A [symbol] | 3572 - <1> - 3574 [symbol] |
| n92 [symbol] | 15 KHz [symbol] | Case A [symbol] | 3584 - <1> - 3787 [symbol] |
| n93 [symbol] | 15 KHz [symbol] | Case A [symbol] | 3572 - <1> - 3574 [symbol] |
| n94 [symbol] | 15 KHz [symbol] | Case A [symbol] | 3584 - <1> - 3787 [symbol] |
| n96 [symbol] | 30 KHz [symbol] | Case C [symbol] | 9531 - <1> - 10363 [symbol] |

Table 2: frequency bands and subcarrier spacings configured by the protocol

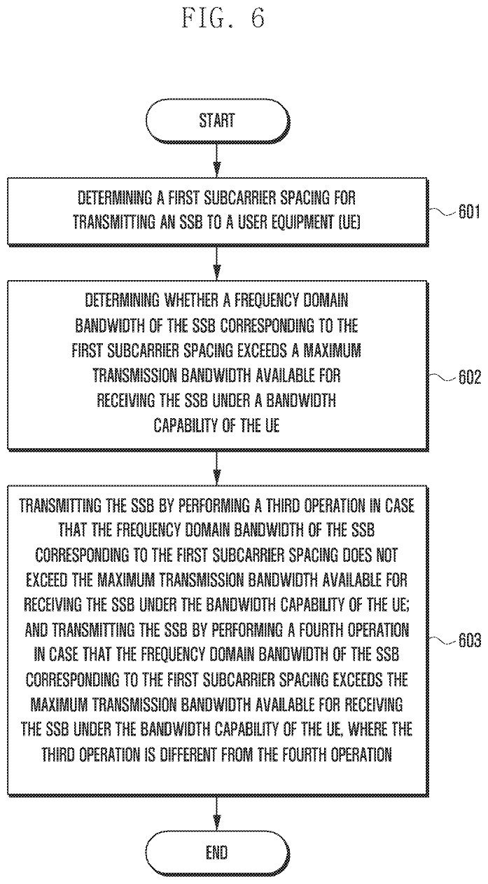

FIG. 6 illustrates a method performed by a base station in a wireless communication system according to an embodiment of the present disclosure. At step 601, the base station may determine a first subcarrier spacing for transmitting a SSB to a user equipment (UE). For example, the BS may determine a frequency band for transmitting the SSB to the UE; determine one or more subcarrier spacings corresponding to the frequency band based on a predetermined rule; and determine a second subcarrier spacing as the first subcarrier spacing in case that the determined one or more subcarrier spacings only include the second subcarrier spacing (e.g., 15 KHz); determine a third subcarrier spacing as the first subcarrier spacing in case that the determined one or more subcarrier spacings only include the third subcarrier spacing (e.g., 30 KHz); determine the second subcarrier spacing as the first subcarrier spacing in case that the determined one or more subcarrier spacings include the second subcarrier spacing and the third subcarrier, where the second subcarrier spacing is smaller than the third subcarrier spacing, and a frequency domain bandwidth of the SSB corresponding to the second subcarrier spacing (e.g., 15 KHz) does not exceed a maximum transmission bandwidth available for receiving the SSB under bandwidth capability (e.g., 5 MHz) of the UE, while a frequency domain bandwidth of the SSB corresponding to the third subcarrier spacing (e.g., 30 KHz) exceeds the maximum transmission bandwidth available for receiving the SSB under the bandwidth capability (e.g., 5 MHz) of the UE. For example, the base station may determine the subcarrier spacing corresponding to the frequency band in which the SSB is to be transmitted to the UE based on specification of the protocol, as shown in Table 2. For example, when the frequency band in which the SSB is to be transmitted to the UE is n51, the subcarrier spacing corresponding to n51 is 15 KHz. When the frequency band in which the SSB is to be transmitted to the UE is n77, the subcarrier spacing corresponding to n77 is 30 KHz. When the frequency band in which the SSB is to be transmitted to the UE is n90, the subcarrier spacings corresponding to n90 are 15 KHz and 30 KHz. However, methods for the base station to determine the subcarrier spacing corresponding to the frequency band in which the SSB is to be transmitted to the UE are not limited thereto. For another example, the base station may determine the frequency band for transmitting the SSB to the UE by other rules. The base station determines the subcarrier spacing corresponding to the frequency band in which the SSB is to be transmitted to the UE.

At step 602, the base station determines whether a frequency domain bandwidth of the SSB corresponding to the first subcarrier spacing exceeds a maximum transmission bandwidth available for receiving the SSB under bandwidth capability of the UE. At step 603, the base station may transmit the SSB by performing a third operation in case that the frequency domain bandwidth of the SSB corresponding to the first subcarrier spacing does not exceed the maximum transmission bandwidth available for receiving the SSB under the bandwidth capability of the UE; and the base station may transmit the SSB by performing a fourth operation in case that the frequency domain bandwidth of the SSB corresponding to the first subcarrier spacing exceeds the maximum transmission bandwidth available for receiving the SSB under the bandwidth capability of the UE, where the third operation is different from the fourth operation. The method described referring FIG. 6 can ensure that the SSB bandwidth is within the processing bandwidth of the terminal, reduce the complexity of UE blind detection, and increase the success rate of PBCH demodulation, thus increasing the success rate of terminal access to the network.

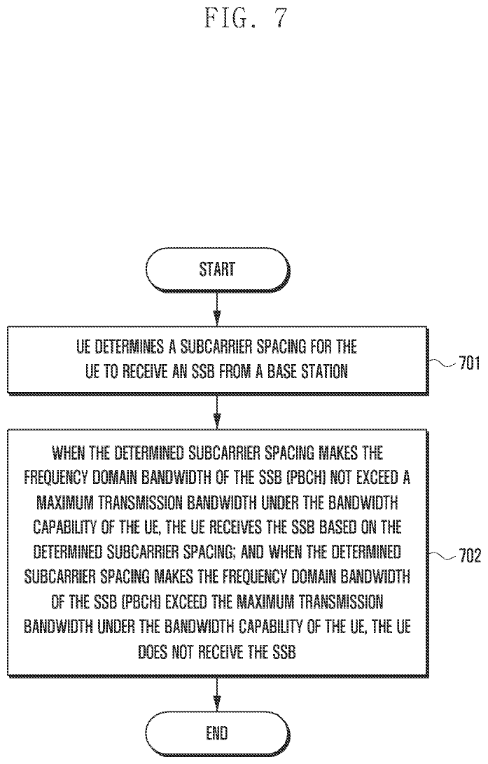

Embodiments of the present disclosure are further described below with reference to FIGS. 7-27. Each of the methods described herein referring FIGS. 5-27 can be implemented separately. Alternatively, a part of the steps of a method can be implemented separately. Alternatively, some or all steps of a method can be implemented in combination with some or all steps of any other example or examples.

FIG. 7 illustrates a method performed by a UE in a wireless communication system according to an embodiment of the present disclosure. At step 701, the UE determines a subcarrier spacing corresponding to a frequency band in which the UE is to receive a SSB from a base station.

It is specified in the protocol that the PSS/SSS/PBCH in a SSB have a same subcarrier spacing, and the subcarrier spacing of the SSB is predefined by the frequency band it belongs to, as shown in Table 2 above. For frequency band n77/n78/79, the system only supports a SSB subcarrier spacing of 30 KHz, and for frequency band n5/n34/n38/n39/n41/n66/n90, the system supports subcarrier spacings of 30 KHz and 15 KHz simultaneously. Step 701 is basically the same as a part of step 501, so it will not be repeatedly described herein.

At step 702, when the determined subcarrier spacing makes the frequency domain bandwidth of the SSB (PBCH) not exceed a maximum transmission bandwidth under the bandwidth capability of the UE, the UE receives the SSB based on the determined subcarrier spacing; and when the determined subcarrier spacing makes the frequency domain bandwidth of the SSB (PBCH) exceed the maximum transmission bandwidth under the bandwidth capability of the UE, the UE does not receive the SSB. For example, when the UE supports a maximum bandwidth of 5 MHz and the determined subcarrier spacing is 30 KHz, the frequency domain bandwidth of the SSB (PBCH) is larger than the maximum transmission bandwidth under the bandwidth capability of the UE, and in this case, the UE does not receive the SSB. Referring to Table 2, for a frequency band that only supports a SSB subcarrier spacing of 30 KHz, the system does not support the access of a redcap UE (hereinafter, it may be simply referred to as a small-bandwidth UE or a small-bandwidth redcap UE) with a maximum transmission bandwidth under the bandwidth capability smaller than the SSB bandwidth, that is, the access of a redcap UE with a maximum transmission bandwidth under the bandwidth capability smaller than the SSB bandwidth is not supported in the frequency band n77/n78/79. As described before, the RedCap 5 MHz bandwidth only supports a SS Block subcarrier spacing of 15 KHz, and for a frequency band that supports both SSB subcarrier spacings of 30 KHz and 15 KHz, the subcarrier spacing is limited to 15 KHz, which is used to support a redcap UE with a maximum transmission bandwidth under the bandwidth capability smaller than the SSB bandwidth. When the subcarrier spacing of these frequency bands (e.g., n5, n34, n38, n39, n41, n66, n90) is set to 30 KHz, the system does not support the access of a small-bandwidth (e.g., 5 MHz) redcap UE. That is, the small-bandwidth redcap UE is not supported in the frequency band n5/n34/n38/n39/n41/n66/n90 with a subcarrier spacing of 30 KHz. On the base station side, the base station still transmits the SSB based on the determined subcarrier spacing of 30 KHz. This way can increase the compatibility to the existing system design. The method described referring FIG. 7 can ensure that the SSB bandwidth is within the processing bandwidth of the terminal and reduce the complexity of UE blind detection.

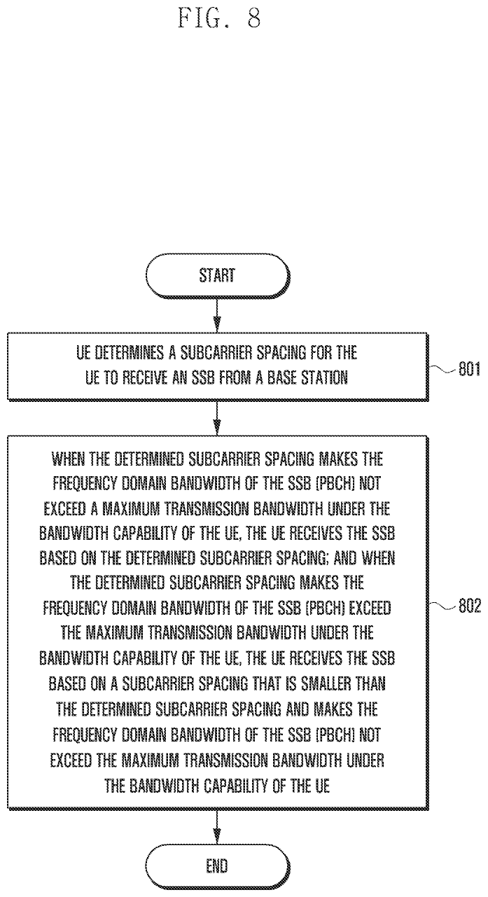

FIG. 8 illustrates a method performed by a UE in a wireless communication system according to an embodiment of the present disclosure. At step 801, the UE determines a subcarrier spacing corresponding to a frequency band in which the UE is to receive a SSB from a base station. Step 801 is basically the same as a part of step 501, so it will not be repeatedly described herein.

At step 802, when the determined subcarrier spacing makes the frequency domain bandwidth of the SSB (PBCH) not exceed a maximum transmission bandwidth under the bandwidth capability of the UE, the UE receives the SSB based on the determined subcarrier spacing; and when the determined subcarrier spacing makes the frequency domain bandwidth of the SSB (PBCH) exceed the maximum transmission bandwidth under the bandwidth capability of the UE, the UE receives the SSB based on a subcarrier spacing that is smaller than the determined subcarrier spacing and makes the frequency domain bandwidth of the SSB (PBCH) not exceed the maximum transmission bandwidth under the bandwidth capability of the UE. For example, when the UE supports a maximum bandwidth of 5 MHz and the determined subcarrier spacing is 30 KHz, the frequency domain bandwidth of the SSB (PBCH) is larger than the maximum transmission bandwidth under the bandwidth capability of the UE. In this case, the UE may receive the SSB based on a subcarrier spacing (e.g., 15 KHz) that makes the frequency domain bandwidth of the SSB (PBCH) be within the maximum transmission bandwidth under the bandwidth capability of the UE. The method described referring FIG. 8 can increase the success rate of the UE access to the network.

Accordingly, on the base station side, when the subcarrier spacing determined by the base station makes the frequency domain bandwidth of the SSB (PBCH) not exceed the maximum transmission bandwidth under the bandwidth capability of the UE, the base station transmits the SSB based on the determined subcarrier spacing; and when the subcarrier spacing determined by the base station makes the frequency domain bandwidth of the SSB (PBCH) exceed the maximum transmission bandwidth under the bandwidth capability of the UE, the base station transmits the SSB based on a subcarrier spacing that is smaller than the determined subcarrier spacing and makes the frequency domain bandwidth of the SSB (PBCH) not exceed the maximum transmission bandwidth under the bandwidth capability of the UE. For example, when the UE supports a maximum bandwidth of 5 MHz and the determined subcarrier spacing is 30 KHz, the frequency domain bandwidth of the SSB (PBCH) is larger than the maximum transmission bandwidth under the bandwidth capability of the UE. In this case, the base station may transmit the SSB based on a subcarrier spacing (e.g., 15 KHz) that makes the frequency domain bandwidth of the SSB (PBCH) be within the maximum transmission bandwidth under the bandwidth capability of the UE, instead of the determined subcarrier spacing of 30 KHz.

For example, the compatibility to the existing system design may be increased by definition of the protocol, as shown in Table 3 and Table 4 below. By specifying whether to support for 5 MHz bandwidth processing capability of n77, n78 and n79 corresponding to a subcarrier spacing of 15 KHz as “YES” in Table 3, or by adding the subcarrier spacings corresponding to n77, n78, and n79 in Table 4, n77, n78, and n79, which only support a subcarrier spacing of 30 KHz in Table 2, are expanded to also support a subcarrier spacing of 15 KHz.

TABLE 3

| | | whether to support for 5 MHz |
|---|---|---|
| NR frequency band | SCS (KHz) | bandwidth processing capability |
| n77 | 15 | YES |
| n78 | 15 | YES |
| n79 | 15 | YES |

TABLE 4

| NR frequency band | SCS (KHz) | Pattern |
|---|---|---|
| n77 | 15 kHz | Case A |
| | 30 kHz | Case C |
| n78 | 15 kHz | Case A |
| | 30 kHz | Case C |
| n79 | 15 kHz | Case A |
| | 30 kHz | Case C |

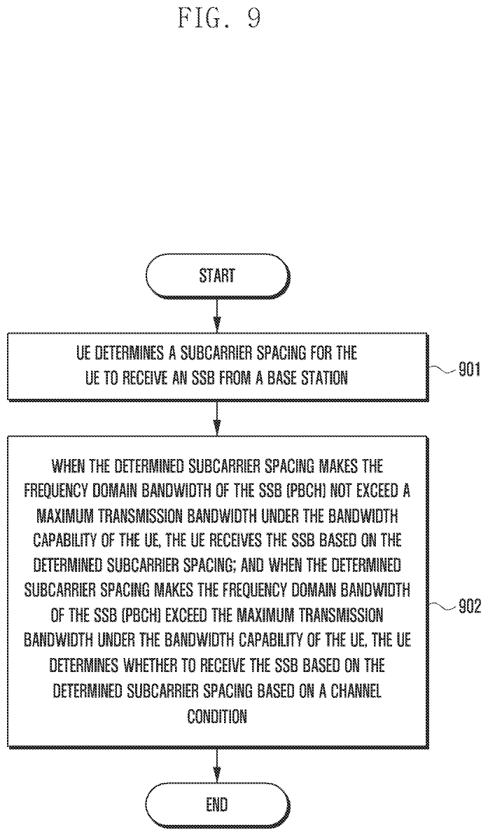

FIG. 9 illustrates a method performed by a UE in a wireless communication system according to an embodiment of the present disclosure. At step 901, the UE determines a subcarrier spacing for the UE to receive a SSB from a base station. Step 901 is basically the same as step 501, and will not be repeatedly described herein.

At step 902, when the determined subcarrier spacing makes the frequency domain bandwidth of the SSB (PBCH) not exceed a maximum transmission bandwidth under the bandwidth capability of the UE, the UE receives the SSB based on the determined subcarrier spacing; and when the determined subcarrier spacing makes the frequency domain bandwidth of the SSB (PBCH) exceed the maximum transmission bandwidth under the bandwidth capability of the UE, the UE determines whether to receive the SSB based on the determined subcarrier spacing based on a channel condition. When the channel condition of the UE is good (for example, the channel condition meets a predetermined condition, for example, a SINR is higher than a predetermined threshold), even if the bandwidth capability of the UE is smaller than the SSB transmission bandwidth, it is still possible to correctly receive all SSBs, and the SSB may be received directly under the existing bandwidth capability. The method described referring FIG. 9 can increase the success rate of the UE to access the network under certain channel conditions.

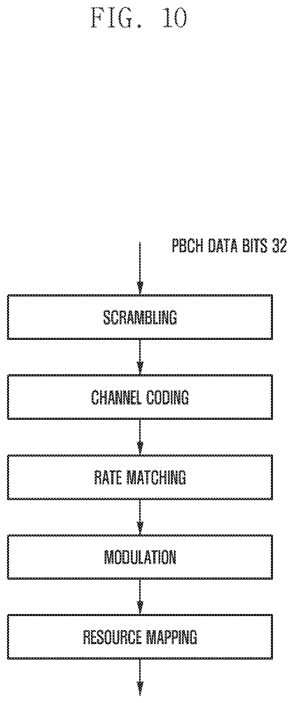

A PBCH data transmission processing flow specified by the protocol is shown in FIG. 10. PBCH data is scrambled, channel coded, rate matched, modulated and resource mapped in sequence.

PBCH data is of 32 bits, of 56 bits after being added a CRC of 24 bits, and the maximum output of PBCH using Polar code is of 512 bits.

The density of DMRS is 3 REs/symbols/PRB, the number of available data transmission REs in a SSB is 432, and QPSK modulation can map 864 coded bits. Therefore, when modulating, there is a certain redundancy, and some bits need to be repeated, with a code rate of 0.59 (corresponding to QPSK MCS4).

For the UE with bandwidth capability of 5 MHz, as described before, the protocol specifies that the maximum transmission bandwidth actually available for data reception is 3.96 MHz. The limited transmission bandwidth leads to a reduction of data reception by 240 (84+84+72) REs for the PBCH, and the number of actual available data transmission REs is 192. The QPSK modulation maps 384 coded bits, and the code rate is 1.33 (corresponding to QPSK MCS9) in this case.

Based on this, when the channel condition of the redcap UE is good, the SSB may be received directly under the existing bandwidth capability. As shown in FIG. 10, the transmission bandwidth actually available for SSB reception by the UE with bandwidth capability of 5 MHz is 3.96 MHz, and the UE only processes SSB reception within the transmission bandwidth for SSB.

In this case, for a frequency band with a SSB subcarrier spacing of 30 KHz, the UE may receive the SSB and perform PBCH demodulation using PBCH data within the transmission bandwidth.

For example, the compatibility to the existing system design may be increased by definition of the protocol, as shown in Table 5 below. In Table 5, whether to support for 5 MHz bandwidth processing capability of n77, n78 and n79 corresponding to a subcarrier spacing of 30 KHz is specified as “YES”.

TABLE 5

| | | whether to support for 5 MHz |
|---|---|---|
| NR Band | SCS (kHz) | bandwidth processing capability |
| n77 | 30 | YES |
| n78 | 30 | YES |
| n79 | 30 | YES |

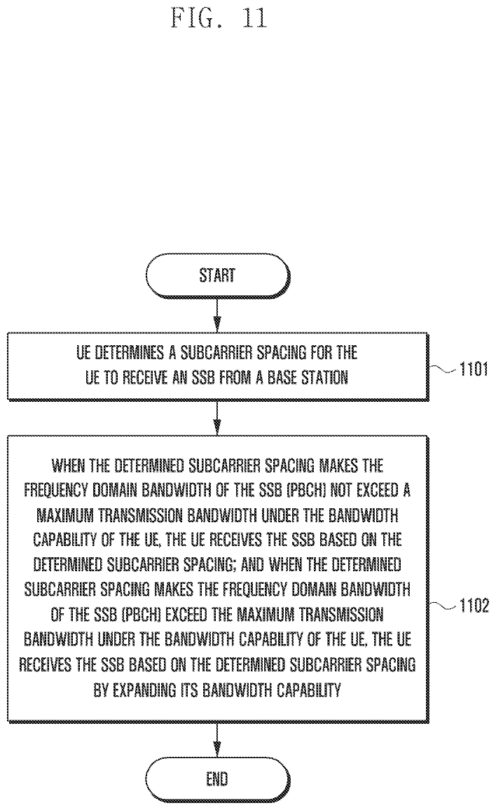

FIG. 11 illustrates a method performed by a UE in a wireless communication system according to an embodiment of the present disclosure. At step 1101, the UE determines a subcarrier spacing for the UE to receive a SSB from a base station. Step 1101 is basically the same as step 1101, and will not be repeatedly described herein.

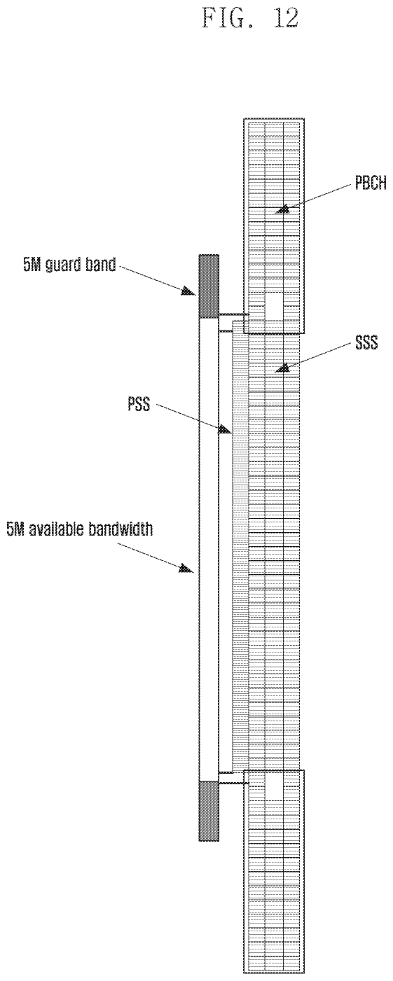

At step 1102, when the determined subcarrier spacing makes the frequency domain bandwidth of the SSB (PBCH) not exceed a maximum transmission bandwidth under the bandwidth capability of the UE, the UE receives the SSB based on the determined subcarrier spacing; and when the determined subcarrier spacing makes the frequency domain bandwidth of the SSB (PBCH) exceed the maximum transmission bandwidth under the bandwidth capability of the UE, the UE receives the SSB based on the determined subcarrier spacing by expanding its bandwidth capability. Specifically, the UE may improve the PBCH reception performance by shortening the frequency guardband (increasing the available band, that is, increasing the maximum transmission bandwidth under the bandwidth capability of the UE). For example, as described before, for the redcap UE with bandwidth capability of 5 MHz, the maximum transmission bandwidth that may be detected at a subcarrier spacing of 30 KHz is 11*12*30 KHz=3.96 MHz, and correspondingly, the bandwidth of the reserved band (i.e., the frequency guardband)=5 MHz-3.96 MHz=1.04 MHz, as shown in FIG. 12. For example, the UE may increase the maximum transmission bandwidth from 3.96 MHz to no more than 5 MHz, etc., and the specific increasing method depends on the implementation of the UE. The method described referring FIG. 11 can increase the success rate of the UE to access the network.

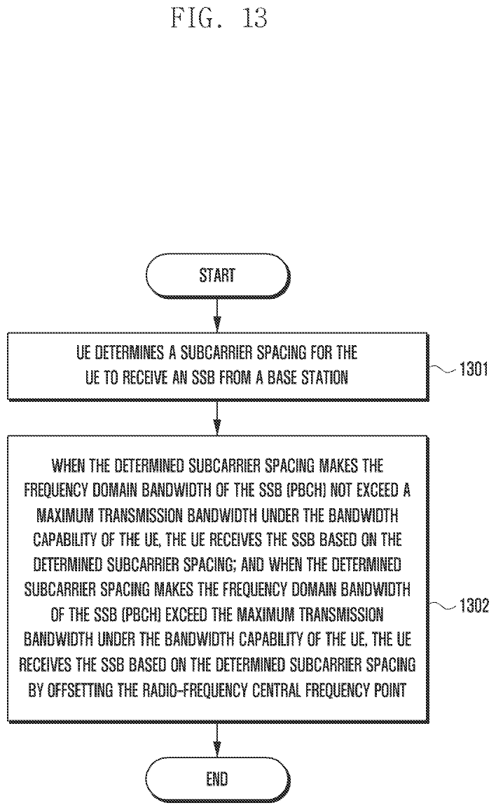

FIG. 13 illustrates a method performed by a UE in a wireless communication system according to an embodiment of the present disclosure. At step 1301, the UE determines a subcarrier spacing for the UE to receive a SSB from a base station. Step 1301 is basically the same as step 501, and will not be repeatedly described herein.

At step 1302, when the determined subcarrier spacing makes the frequency domain bandwidth of the SSB (PBCH) not exceed a maximum transmission bandwidth under the bandwidth capability of the UE, the UE receives the SSB based on the determined subcarrier spacing; and when the determined subcarrier spacing makes the frequency domain bandwidth of the SSB (PBCH) exceed the maximum transmission bandwidth under the bandwidth capability of the UE, the UE receives the SSB based on the determined subcarrier spacing by offsetting the radio-frequency central frequency point. The method described referring FIG. 13 can increase the success rate of the UE to access the network.

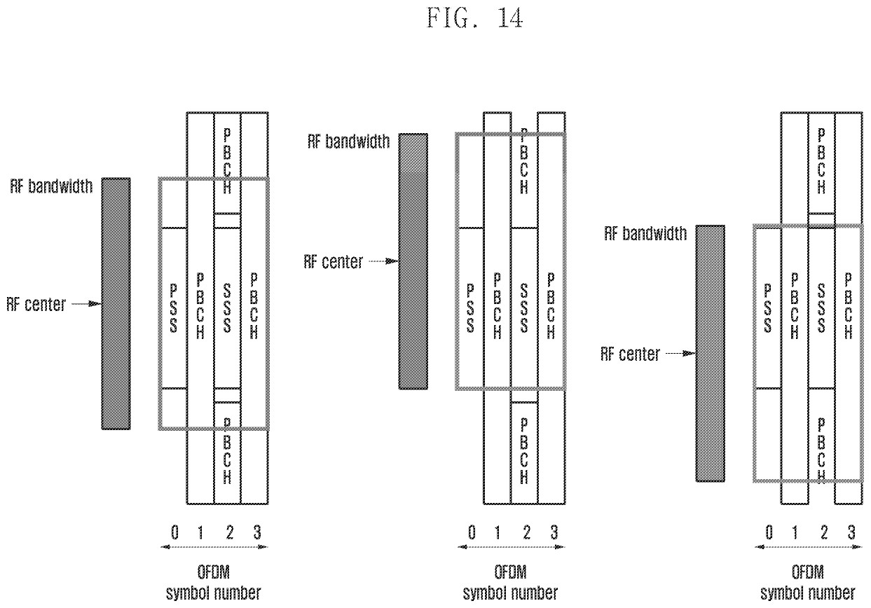

In a channel environment with large frequency selectivity, different locations of the radio-frequency (RF) central frequency point of the UE will lead to different performance for decoding. The UE may receive PBCH signal with delta offset of the radio-frequency central frequency. Delta may be defined as a gap between the radio-frequency central frequency point of the UE and a SSB central frequency point. As shown in FIG. 14. The value of delta is related to a frequency selection characteristic and depends on the UE implementation.

The subcarrier with a subcarrier index of 120 in a SSB can only be transmitted on a synchronization raster, which is beneficial to improve the efficiency of UE blind detection, and thus achieve downlink synchronization rapidly. When the UE detects the SSB, it searched with its RF center frequency according to the synchronization raster. When the UE RF central frequency point is aligned with the SSB central frequency point (the subcarrier with a subcarrier index of 120 in the SSB), as shown in the left diagram of FIG. 14. The radio-frequency central frequency point of the UE may move up and down in the frequency band to obtain better demodulation performance. When the central frequency point moves to a higher frequency, the value of delta is positive, and vice versa.

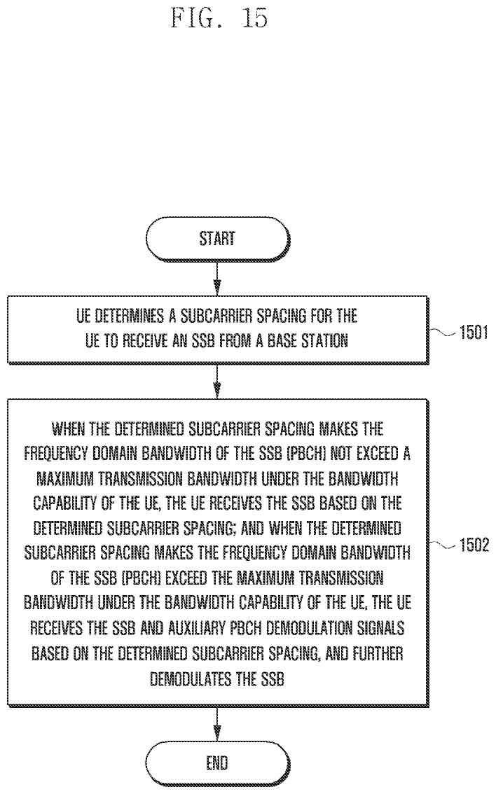

FIG. 15 illustrates a method performed by a UE in a wireless communication system according to an embodiment of the present disclosure. At step 1501, the UE determines a subcarrier spacing for the UE to receive a SSB from a base station. Step 1501 is basically the same as step 501, so it will not be repeatedly described herein.

At step 1502, when the determined subcarrier spacing makes the frequency domain bandwidth of the SSB (PBCH) not exceed a maximum transmission bandwidth under the bandwidth capability of the UE, the UE receives the SSB based on the determined subcarrier spacing; and when the determined subcarrier spacing makes the frequency domain bandwidth of the SSB (PBCH) exceed the maximum transmission bandwidth under the bandwidth capability of the UE, the UE receives the SSB and an auxiliary PBCH demodulation signal (also called auxiliary SSB demodulation signal, auxiliary PBCH signal, auxiliary demodulation signal, auxiliary signal, etc.) based on the determined subcarrier spacing, and further demodulates the SSB. The method described referring FIG. 15 can increase the success rate of the UE to access the network.

Correspondingly, on the base station side, when the subcarrier spacing determined by the base station makes the frequency domain bandwidth of the SSB (PBCH) not exceed the maximum transmission bandwidth under the bandwidth capability of the UE, the base station transmits the SSB based on the determined subcarrier spacing; and when the determined subcarrier spacing makes the frequency domain bandwidth of the SSB (PBCH) exceed the maximum transmission bandwidth under the bandwidth capability of the UE, the base station transmits the SSB and the auxiliary PBCH demodulation signal (also called auxiliary SSB demodulation signal, auxiliary PBCH signal, auxiliary demodulation signal, auxiliary signal, etc.) based on the determined subcarrier spacing, in order for the UE to demodulate the SSB. The following describes the auxiliary PBCH demodulation signal.

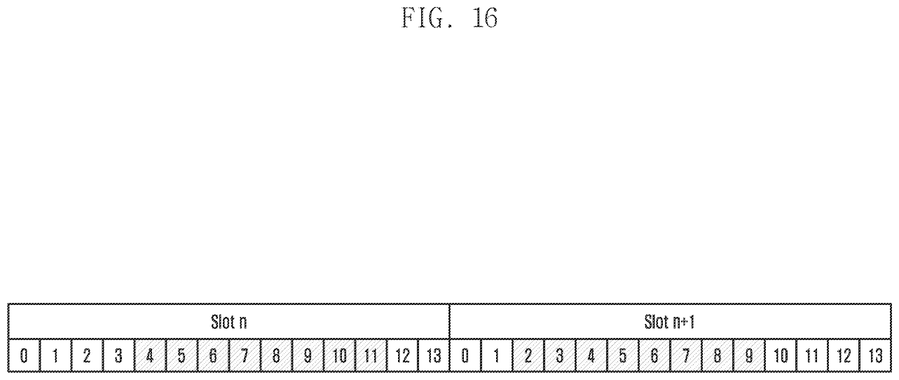

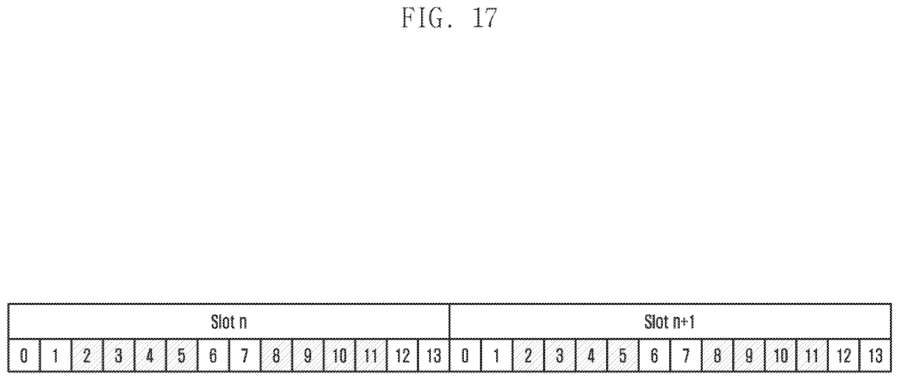

In the prior art, a set of SSBs (SS burst set) consists of at most N SSBs, and N is determined by the frequency point. SSBs in the SS burst set are concentrated in a half-frame (5 ms) to be transmitted. The protocol specifies transmission symbol positions of the SSB set in the half-frame, and the base station transmits the SSBs at the corresponding symbol positions according to the cell frequency point and subcarrier spacing etc. Taking the subcarrier spacing of 30 KHz as an example, the system supports
caseB: the starting symbol position of SSB is {4, 8, 16, 20}+28*n, as shown in FIG. 16.
caseC: the starting symbol position of SSB is {2, 8}+14*n, as shown in FIG. 17.

As shown in FIG. 16, Symbols 4-7 in Slot n are the time domain locations of the first SSB in the SS burst set, symbol 8s-11 are the time domain locations of the second SSB, Symbols 2-5 in slot n+1 are the time domain locations of the third SSB in the SS burst set, and symbols 6-9 are the time domain locations of the fourth SSB.

Taking caseC as an example, as shown in FIG. 17, for the symbol intervals between SSBs at the front, middle and end of a slot,
Symbols 0 and 1 can be used to transmit a downlink control channel (PDCCH);
Symbols 6 and 7 can be used to transmit certain downlink data; and
Symbols 12 and 13 can be used for uplink reception.

For a SSB with a subcarrier spacing of 30 KHz, the base station may copy the resource blocks (REs) of the PBCH at frequency domain locations that exceeds the maximum transmission bandwidth under the bandwidth capability of redcap to the interval symbols before and/or after the SSB as auxiliary PBCH demodulation signals.

The Redcap UE performs reception according to the time-frequency domain locations of the SSB and the time-frequency domain locations of the auxiliary PBCH demodulation signals, while the non-redcap UE may perform reception still according to the existing SSB time-frequency domain locations without being aware of the newly added PBCH signals. At the same time, the terminal receives a truncated SSB signal for a frequency band that supports a minimum bandwidth of 3 MHz to 5 MHz. This method can also be used to improve the reception performance of PBCH in this scenario. The following design is illustrated by taking RedCap UE as an example.

There are two methods to configure the auxiliary PBCH demodulation signals.

### Method 1: UE Additionally Receives Auxiliary PBCH Demodulation Signals of Two Symbols

In Method 1, on the basis of the existing SSB design, the base station additionally transmits, on two symbols, PBCH data whose PBCH exceeds the maximum transmission bandwidth under the bandwidth capability of the Redcap UE, for the Redcap UE to perform PBCH demodulation.

The frequency domain locations of a PBCH DMRS are determined by a cell number, as shown in Table 6 below. The time domain locations of the DMRS for the PBCH are symbols 1, 2, 3, and the frequency domain locations thereof are subcarriers 0+v, 4+v, . . . , where v is the modulo of the cell number to 4. Therefore, the frequency domain subcarrier locations of the DMRS for the PBCH varies as the cell number varies.

TABLE 6

| | OFDM symbol index l | Subcarrier index k |
|---|---|---|
| Channel or | relative to the starting | relative to the starting |
| signal | symbol of SSB | symbol of SSB |
| DMRS for | 1, 3 | 0 + v, 4 + v, 8 + v, . . . , 236 + v |
| PBCH | 2 | 0 + v, 4 + v, 8 + v, . . . 44 + v |
| | | 192 + v, 196 + v, . . . , 236 + v |

When the PBCH signal to be copied to the other two symbols is truncated according to the maximum transmission bandwidth under the bandwidth capability of the UE, the number of resource elements (REs) of the truncated PBCH will vary with the cell number and the central frequency point location of the UE, therefore, all of the PBCH data exceeding the maximum transmission bandwidth under the bandwidth capability of the Redcap UE may be truncated, or a part of the PBCH data exceeding the maximum transmission bandwidth under the bandwidth capability of the Redcap UE may be truncated. In order to better unify the applicability of the scheme, the PBCH signal may be truncated according to the frequency domain locations of the PSS/SSS, and the number of truncated REs should be an integer multiple of 4.

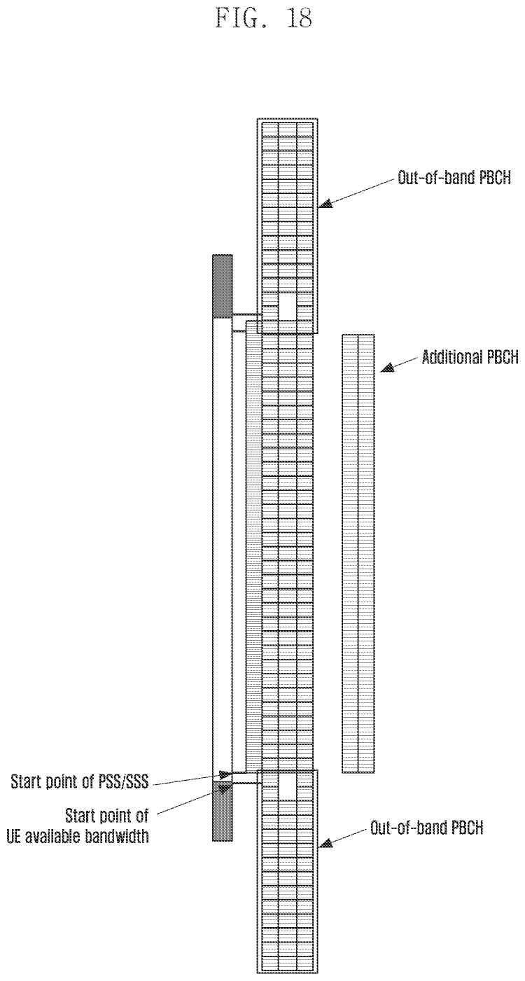

Taking a UE bandwidth capability of 5 MHz as an example, when the central frequency point of the UE is the same as the central frequency point of the PSS, the starting frequency location of the UE is different from that of the PSS by 3 REs, as shown by the starting locations in FIG. 18. In this case, there are 246 (87+87+72) REs of PBCH data outside the maximum transmission bandwidth under the bandwidth capability of the UE. These REs are repeated by the base station on two additional symbols and are placed within the maximum transmission bandwidth available for the UE, as shown in FIG. 18 below. Therefore, the UE receives signals on these two symbols in addition to the SSB.

The method may be combined with the operation for the UE to offset the radio-frequency central frequency point in the method described referring FIG. 13. When the location of the central frequency point of the UE is different, the locations of PBCH REs exceeding the maximum transmission bandwidth available for the UE are different.

The location of the auxiliary PBCH demodulation signal may be indicated by adding two symbols in an existing table of the protocol, as shown in Table 7 below, that is, the values of k when l=4 and 5. However, the values of k when l=4 and 5 are only examples, and k may have other values, for example, when l=4, k=56, 57, ˜, 178, while when l=5, k=56, 57, ˜, 178.

TABLE 7

| | OFDM symbol index l | Subcarrier index k |
|---|---|---|
| Channel | relative to the starting | relative to the starting |
| or signal | symbol of SSB | symbol of SSB |
| PSS | 0 | 56, 57, . . . 182 |
| SSS | 2 | 56, 57, . . . 182 |
| Set to 0 | 0 | 0, 1, . . . 55, 183, 184, . . . |
| | 2 | 48, 49, . . . 55, 183, 184, . . . |
| PBCH | 1, 3 | 0, 1, . . . 239 |
| | 2 | 0, 1, . . . 47, |
| | | 192, 193, . . . 239 |
| | 4 | 56, 57, . . . |
| | 5 | 56, 57, . . . |
| DM-RS for | 1, 3 | 0 + v, 4 + v, 8 + v, . . . , 236 + v |
| PBCH | 2 | 0 + v, 4 + v, 8 + v, . . . 44 + v |
| | | 192 + v, 196 + v, . . . , 236 + v |

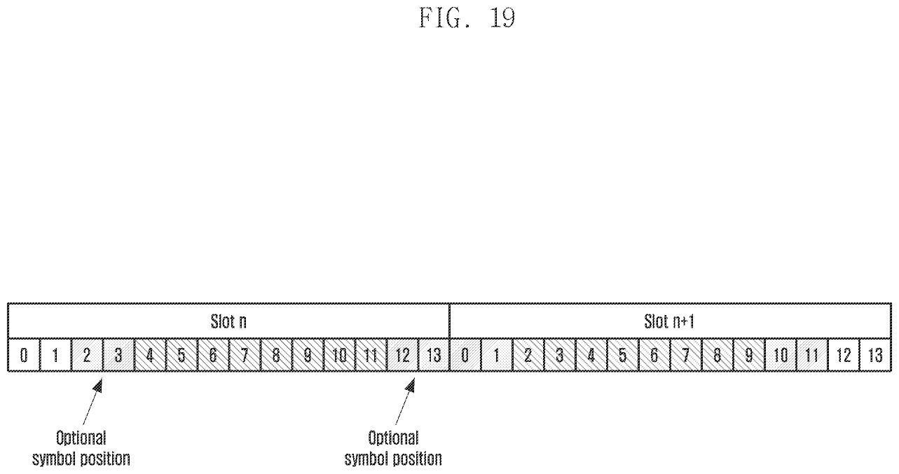

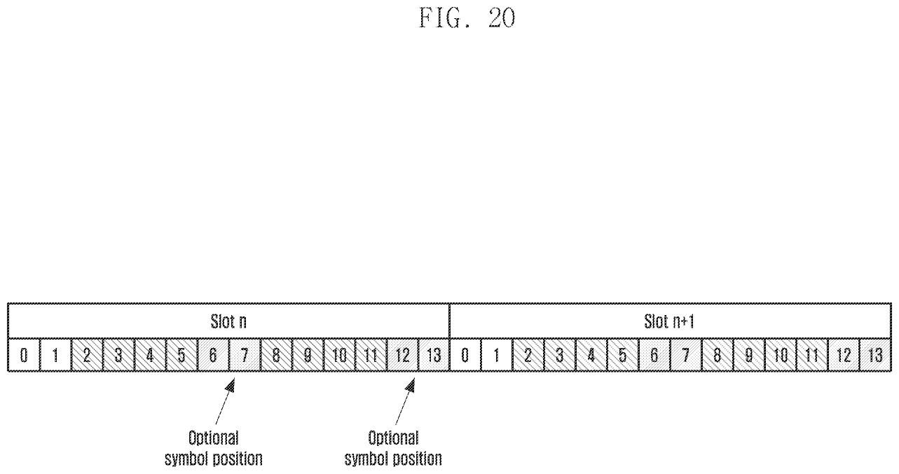

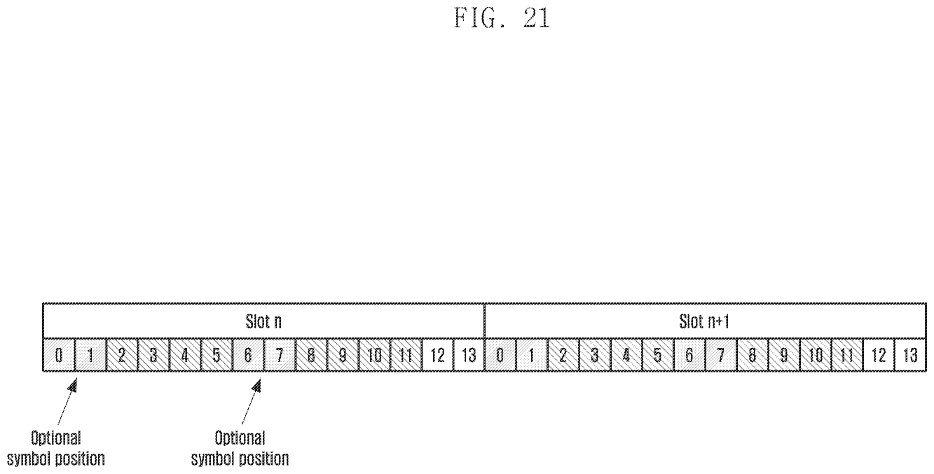

The time domain symbol position of the SSB may be set according to different cases:
caseB: the starting symbol position of the SSB is {4, 8, 16, 20}+28*n, as shown in FIG. 16. In case of a redcap, the starting symbol position of the SSB is {2, 8, 14, 20}+28*n, as shown in FIG. 19.
caseC: the starting symbol position of the SSB is {2, 8}+14*n, or the starting symbol position of the SSB is {0, 6}+14*n, as shown in FIGS. 20 and 21.

Particularly, when the auxiliary PBCH demodulation signal is transmitted before the PSS signal, the UE may not be able to store the PBCH while the PSS is detected, but the UE may receive and demodulate the PBCH at the next SSB period location.

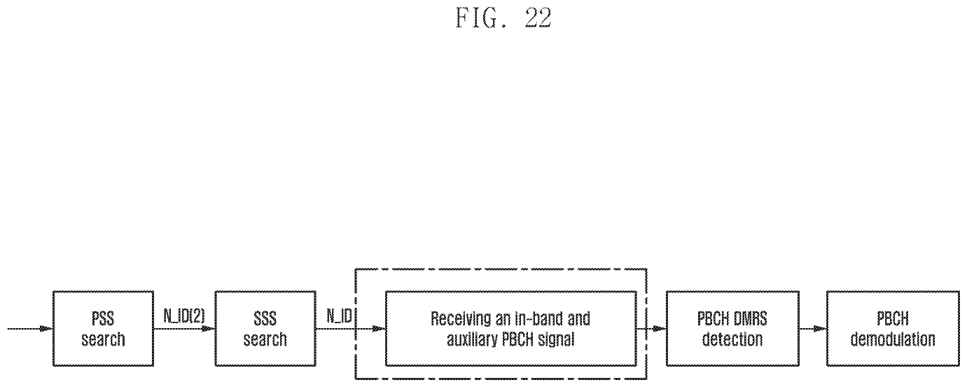

The Redcap UE should additionally receive PBCH data at the optional symbol time domain locations and the corresponding frequency domain locations, and then perform PBCH demodulation, as shown in FIG. 22.
At first, the UE searches a primary synchronization signal (PSS) by means of an existing algorithm, and obtains a parameter N_ID(2) for determining a physical-layer cell identity (ID) number of a cell, and a symbol boundary, as well as a SSB subcarrier spacing according to the PSS sequence.
Then, the UE searches a secondary synchronization signal (SSS) according to a relative location in the time-frequency domain by means of the existing algorithm, and obtains a parameter N_ID(1) for determining the physical cell ID similarly. In this case, the physical cell ID is N_ID=3*N_ID(1)+N_ID(2).

When the SSB subcarrier spacing is 30 KHz and/or the UE is a small bandwidth capability (for example, 5 MHz) UE and/or the frequency band of the UE is n77/n78/n79, the following steps are initiated:
The UE determines the time-frequency location of the PBCH and the time-frequency location of the auxiliary PBCH demodulation signal according to the relative location in the time-frequency domain, and/or offsets the UE radio-frequency central location by delta to the frequency point f corresponding to GSCN, and with the offset UE radio-frequency bandwidth may cover a part of the PBCH signals. Then, the UE receives, stores the PBCH and auxiliary PBCH demodulation signal, and demodulates the PBCH.

### Method 2: UE Receives an Auxiliary PBCH Demodulation Signal of One Symbol

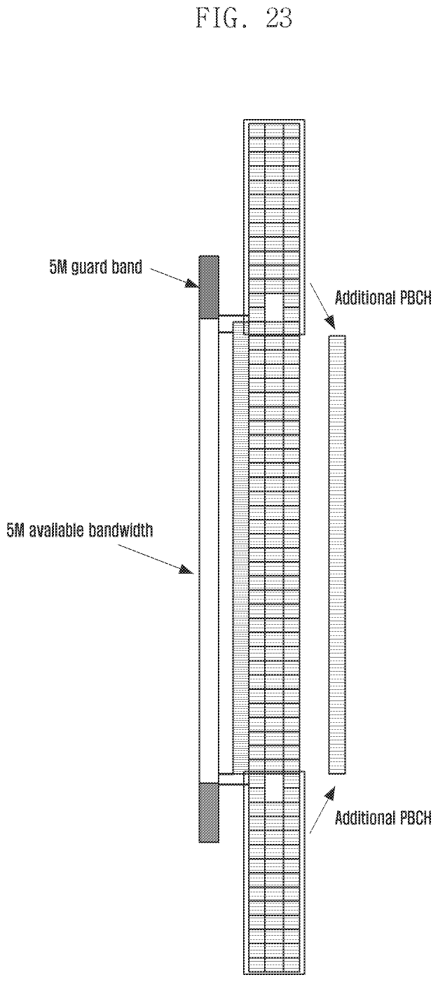

To reduce the time domain overhead, the base station may transmit a part of out-of-band PBCH REs on one additional symbol instead of two symbols, for PBCH demodulation by the redcap UE. The auxiliary PBCH demodulation signal may be aligned with the PSS and SSS to improve the data demodulation performance in joint reception, as shown in FIG. 23.

The location of the auxiliary PBCH may be indicated by adding one symbol in the existing table of the protocol, as shown in Table 8 below, that is, the values of k when l=4.

TABLE 8

| | OFDM symbol index l | Subcarrier index k |
|---|---|---|
| Channel | relative to the starting | relative to the starting |
| or signal | symbol of an SSB | symbol of an SSB |
| PSS | 0 | 56, 57, . . . 182 |
| SSS | 2 | 56, 57, . . . 182 |
| Set to 0 | 0 | 0, 1, . . . 55, 183, 184, . . . 239 |
| | 2 | 48, 49, . . . 55, 183, 184, . . . |
| PBCH | 1, 3 | 0, 1, . . . 239 |
| | 2 | 0, 1, . . . 47, |
| | | 192, 193, . . . 239 |
| | 4 | 56, 57, . . . |
| DM-RS for | 1, 3 | 0 + v, 4 + v, 8 + v, . . . , 236 + v |
| PBCH | 2 | 0 + v, 4 + v, 8 + v, . . . 44 + v |
| | | 192 + v, 196 + v, . . . , 236 + v |

In this case, for a UE with bandwidth capability of 5 MHZ, the number of REs actual available for data transmission is 313 (93+93+127), and 626 coded bits are mapped by QPSK modulation. In this case, the code rate is 0.817 (corresponding to QPSK MCS6), which has a gain compared with direct reception on the maximum transmission bandwidth under the bandwidth capability of the UE.

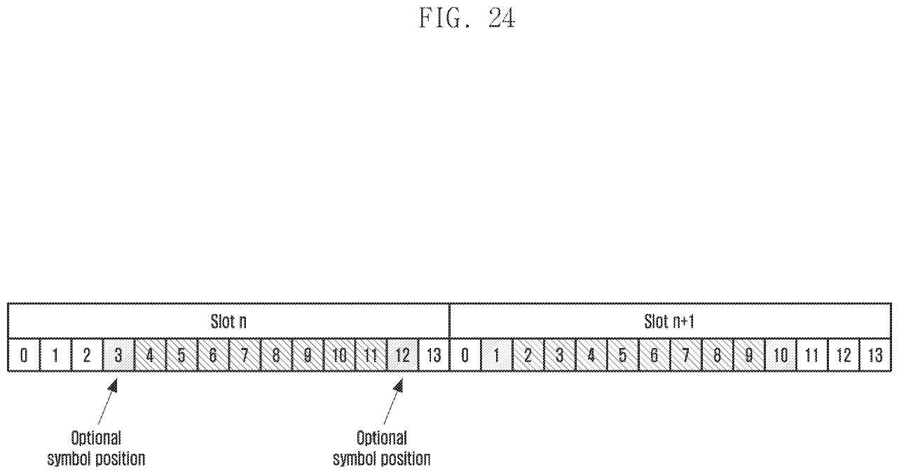

Time domain symbol position may be set according to different cases:
caseB: the starting symbol position of SSB is {4, 8, 16, 20}+28*n. In case of a redcap, the starting symbol position of SSB is {3, 8, 14, 20}+28*n.
CaseC: the starting symbol position of SSB is {2, 8}+14*n or the starting symbol position of SSB is {1, 7}+14*n, as shown in FIGS. 24, 25 and 26.

Similarly, when the auxiliary PBCH demodulation signal is transmitted before the PSS signal, the UE may not be able to store the PBCH while the PSS is detected, but the UE may receive and demodulate the PBCH at the next SSB period location.

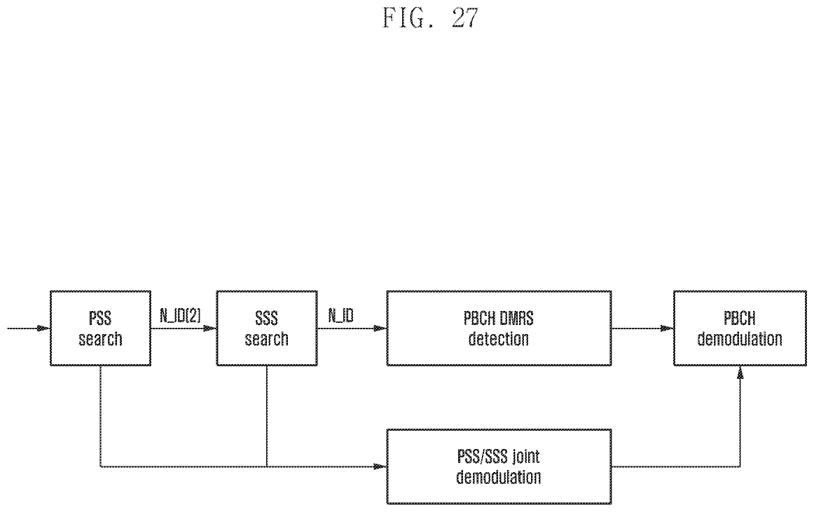

In addition, the Redcap UE receiver may only use the in-band PBCH DMRS for PBCH demodulation, and the reception performance is degraded because the sequence length of PBCH DMRS is shortened in SSB symbols 1 and 3. In order to improve its demodulation performance, this design may also be used in combination with existing algorithms, for example, the UE performs joint reception of the PBCH along with the PSS and SSS, as shown in FIG. 27.

The terminal determines the SSB frequency domain location for receiving the SSB according to frequency band information. It is specified by the protocol that the sync raster is used for cell search by the terminal, and the first RE frequency domain location of the 10th RB of the SSB should be on the sync raster, which can reduce the energy consumption of terminal search and achieve the purpose of power saving. For specific systems such as FRMCS, PPDU and smart utilities, the new SSB frequency domain location design is helpful to ensure the backward compatibility of the terminal. For example, for a terminal that supports the above specific systems, when the search frequency band is some fixed frequency bands (RMR-900, n8, n26, n28, etc.), the terminal may receive the SSB according to the newly defined SSB frequency domain location, while for a terminal that does not support the specific systems, it receives the SSB still according to the existing frequency domain location, thus preventing a terminal that does not support the specific systems from accessing the specific systems.

When the frequency domain range is 0-3000 MHz, the frequency domain of the existing synchronization raster is defined as N*1200 KHz+M*50 KHz, N=1:2499, M∈{1,3,5}. This synchronization raster is used for the frequency band with channel raster spacings of 100 kHz and 15 kHz and a minimum frequency band of 5 MHz. Where the synchronization raster spacing L<=minimum channel bandwidth-SSB frequency band+channel raster spacing.

The frequency domain location of the synchronization raster when the supported minimum channel bandwidth is 3 MHz is calculated according to the formula (synchronization raster spacing L=minimum channel bandwidth-SSB frequency band+3*channel raster spacing), where the minimum channel bandwidth is the effective frequency band (2.7 MHz to 2.85 MHZ) at 3 MHz, and the SSB frequency band is the truncated SSB bandwidth. In an embodiment, the truncated SSB bandwidth is 1.92 MHZ (truncated by the PSS/SSS frequency domain bandwidth plus the bandwidth of one subcarrier), and the synchronization raster spacing L is 1008 kHz (2700-1920+300) to 1230 KHz (2850-1920+300). In this case, when the frequency domain range is 0-3000 MHz, the frequency domain of synchronization raster is defined as N*L+M*50 KHz, N=1:2499, M∈{1,3,5}. This synchronization raster is used for the frequency band with channel raster spacings of 100 kHz and 15 kHz and a minimum frequency band of 3 MHz. When L is equal to 1200 KHz, frequency domain offset may be added to distinguish it from the existing synchronization raster location. In this case, when the frequency domain range is 0-3000 MHz, the frequency domain of synchronization raster is defined as N*1200 KHz+M*50 KHz+delta, N=1:2499, M∈{1,3,5}. In an embodiment, the value of delta is 600 kHz, which may make the synchronization raster more evenly distributed across the frequency band.

The terminal determines how to receive the SSB according to the frequency band information. For frequency bands supporting a minimum bandwidth of 3 MHz to 5 MHZ (such as RMR-900, n8, n26, n28, etc.), SSB truncation is required so that the terminal may receive the SSB within the effective bandwidth of the system. Herein, a truncated SSB means that within the frequency band occupied by SSB, a part of continuous frequency bands are defined for transmission, and other undefined frequency bands are not used for transmission. Herein, the size of the defined bandwidth is determined by the effective bandwidth supported by the system. While the effective bandwidth is the bandwidth of the frequency band supported by the system having the guard interval removed.

Take a system bandwidth of 3M as an example, the supported maximum effective frequency band is 2.7 MHz to 2.85 MHZ (the minimum bandwidth is 90%-95% according to the spectrum utilization rate), and the supported maximum RB number may be 14 or 15 or 16, as shown in Tables 9 and 10 below. The SSB bandwidth with a subcarrier spacing of 15 kHz is 3.6 MHz, and the PSS/SSS bandwidth is 1.905 MHz. For a specific system supporting 3 MHz to 5 MHz, at least all PSS/SSS signals being included is helpful to ensure the synchronization performance of the terminal. In this case, the PSS/SSS bandwidth including the guard interval is 2.16 MHz. When the SSB is transmitted in a specific frequency band (such as RMR-900, n8, n26, n28, etc.), the PBCH in the SSB may be truncated and transmitted within the effective bandwidth, and the terminal may receive the truncated SSB signal.

TABLE 9

| SCS | 3 MHz |
|---|---|
| (kHz) | N_{RB} |
| 15 | 14 |
| 30 | N/A |
| 60 | N/A |
| 15 | 15 |
| 30 | N/A |
| 60 | N/A |

TABLE 10

| SCS | 3 MHz |
|---|---|
| (kHz) | N_{RB} |
| 15 | 16 |
| 30 | N/A |
| 60 | N/A |

Further, a truncated SSB may be that, for the frequency band occupied by the PBCH signal in the SSB, a part of continuous frequency bands are defined for transmission, and other undefined frequency bands are not used for transmission. The following is described by taking SSB truncation as an example.

SSB truncation may by means of the following Sub-method 1, Sub-method 2 or Sub-method 3.

Sub-method 1: A SSB channel is truncated symmetrically with the frequency domain location of synchronization raster in which the SSB is located as the center. In this method, for the truncated SSB, continuous frequency bands are defined by taking the frequency domain location of the first subcarrier of the 10th RB of the SSB as the center. In this way, efforts are made to define the same number of subcarriers on both sides of the frequency domain center. The size of the defined frequency bands is determined based on the effective bandwidth supported by the system.

This method makes the PSS/SSS and PBCH signals have the same frequency domain center, which is beneficial to the terminal in RF energy saving for reception. For example, when the terminal has a small radio frequency band range, after receiving the PSS/SSS, it can receive the PBCH for demodulation without moving the radio frequency center.

Taking the supported maximum bandwidth of 3 MHz as an example, the maximum effective frequency band of the PBCH is 2.7 MHz to 2.85 MHz, and the maximum number of subcarriers for PBCH with a subcarrier spacing of 15 kHz can be 180 to 190. PSS/SSS signals including guardbands occupy 144 subcarriers. Therefore, except frequency domain location occupied by the PSS/SSS, the maximum number of subcarriers that can be additionally occupied by the PBCH in frequency domain is about 36 to 46, and the maximum number of subcarriers additionally distributed on both sides in the frequency domain is 18 to 23. In order to adapt the PBCH DMRS to offset according to the cell ID, the number of subcarriers additionally distributed on both sides should be a multiple of 4, so the number of selectable subcarriers additionally distributed on both sides of the frequency domain is 0, 4, 8, 12, 16 and 20. In this case, for a specific system supporting 3 MHz to 5 MHz, the time-frequency domain locations for transmitting the SSB are shown in Tables 11-17 below.

TABLE 11

| | OFDM symbol index l | Subcarrier index k |
|---|---|---|
| Channel or | relative to the start of | relative to the start |
| signal | an SS/PBCH block | of an SS/PBCH block |
| PSS | 0 | 56, 57, . . . , 182 |
| SSS | 2 | 56, 57, . . . , 182 |
| PBCH | 1, 3 | 56, . . . , 183 |
| DM-RS for | 1, 3 | 56 + v, . . . , 179 + v |
| PBCH | | |

TABLE 12

| Channel | OFDM symbol index l | Subcarrier index k |
|---|---|---|
| or | relative to the start of | relative to the start of |
| signal | an SS/PBCH block | an SS/PBCH block |
| PSS | 0 | 56, 57, . . . , 182 |
| SSS | 2 | 56, 57, . . . , 182 |
| Set to 0 | 0 | 48, 49, . . . , 55, 183, 184, . . . , 191 |
| | 2 | 48, 49, . . . , 55, 183, 184, . . . , 191 |
| PBCH | 1, 3 | 48, . . . , 191 |
| DM-RS | 1, 3 | 48 + v, . . . , 189 + v |
| for PBCH | | |

TABLE 13

| Channel | OFDM symbol index l | Subcarrier index k |
|---|---|---|
| or | relative to the start of | relative to the start of |
| signal | an SS/PBCH block | an SS/PBCH block |
| PSS | 0 | 56, 57, . . . , 182 |
| SSS | 2 | 56, 57, . . . , 182 |
| Set to 0 | 0 | 44, 45, . . . , 55, 183, 184, . . . , 195 |
| | 2 | 48, 49, . . . , 55, 183, 184, . . . , 191 |
| PBCH | 1, 3 | 44, 45, 46, 47, 48, . . . , 191, |
| | | 192, 193, 194, 195 |
| | 2 | 44, 45, 46, 47 |
| | | 192, 193, 194, 195 |
| DM-RS | 1, 3 | 44 + v, 48 + v, . . . , 192 + v |
| for | 2 | 44 + v |
| PBCH | | 192 + v |

TABLE 14

| Channel | OFDM symbol index l | Subcarrier index k |
|---|---|---|
| or | relative to the start | relative to the start |
| signal | of an SS/PBCH block | of an SS/PBCH block |
| PSS | 0 | 56, 57, . . . , 182 |
| SSS | 2 | 56, 57, . . . , 182 |
| Set to 0 | 0 | 40, 41, . . . , 55, 183, 184, . . . , 199 |
| | 2 | 48, 49, . . . , 55, 183, 184, . . . , 191 |
| PBCH | 1, 3 | 40, 41 . . . , 198, 199 |
| | 2 | 40, . . . , 47 |
| | | 192, . . . , 199 |
| DM-RS | 1, 3 | 40 + v, 44 + v, . . . , 196 + v |
| for | 2 | 40 + v, 44 + v |
| PBCH | | 192 + v, 196 + v |

TABLE 15

| Channel | OFDM symbol index l | Subcarrier index k |
|---|---|---|
| or | relative to the start of | relative to the start |
| signal | an SS/PBCH block | of an SS/PBCH block |
| PSS | 0 | 56, 57, . . . , 182 |
| SSS | 2 | 56, 57, . . . , 182 |
| Set to 0 | 0 | 36, 37, . . . , 55, 183, 184, . . . , 203 |
| | 2 | 48, 49, . . . , 55, 183, 184, . . . , 191 |
| PBCH | 1, 3 | 36, 37 . . . , 202, 203 |
| | 2 | 36, . . . , 47 |
| | | 192, . . . , 203 |
| DM-RS | 1, 3 | 36 + v, 40 + v, . . . , 200 + v |
| for | 2 | 36 + v, 40 + v, 44 + v |
| PBCH | | 192 + v, 196 + v, 200 + v |

TABLE 16

| Channel | OFDM symbol index l | Subcarrier index k |
|---|---|---|
| or | relative to the start of | relative to the start |
| signal | an SS/PBCH block | of an SS/PBCH block |
| PSS | 0 | 56, 57, . . . , 182 |
| SSS | 2 | 56, 57, . . . , 182 |
| Set to 0 | 0 | 32, 33, . . . , 55, 183, 184, . . . , 207 |
| | 2 | 48, 49, . . . , 55, 183, 184, . . . , 191 |
| PBCH | 1, 3 | 32, 33 . . . , 206, 207 |
| | 2 | 32, . . . , 47 |
| | | 192, . . . , 207 |
| DM-RS | 1, 3 | 32 + v, 36 + v, . . . , 204 + v |
| for | 2 | 32 + v, 36 + v, 40 + v, 44 + v |
| PBCH | | 192 + v, 196 + v, 200 + v, 204 + v |

TABLE 17

| Channel | OFDM symbol index l | Subcarrier index k |
|---|---|---|
| or | relative to the start of | relative to the start of |
| signal | an SS/PBCH block | an SS/PBCH block |
| PSS | 0 | 56, 57, . . . , 182 |
| SSS | 2 | 56, 57, . . . , 182 |
| Set to 0 | 0 | 28, 29, . . . , 55, 183, 184, . . . , 211 |
| | 2 | 48, 49, . . . , 55, 183, 184, . . . , 191 |
| PBCH | 1, 3 | 28, 29 . . . , 210, 211 |
| | 2 | 28, . . . , 47 |
| | | 192, . . . , 211 |
| DM-RS | 1, 3 | 28 + v, 32 + v, . . . , 208 + v |
| for | 2 | 28 + v, 32 + v, 36 + v, 40 + v, 44 + v |
| PBCH | | 192 + v, 196 + v, 200 + v, |
| | | 204 + v, 208 + v |

Sub-method 2: The SSB channel is truncated with the frequency domain starting location of SSB as the start point. In this method, the location of the first subcarrier of the first RB of the SSB is taken as the start point, and continuous frequency bands are defined, where the size of the limited frequency band is determined by the effective bandwidth supported by the system.

This method has better compatibility than the existing parameter definition. For example, the parameters offsetToPointA and Kssb are defined in terms of the frequency domain starting location of the SSB. Truncating the PBCH channel by starting from the frequency domain starting location of the SSB can reuse the original parameter definition and value range, which has little impact on the parameters in the existing protocol.

Taking the 3 MHz bandwidth as an example, the maximum effective frequency band of the PBCH is 2.7 MHz to 2.85 MHz, and the maximum number of subcarriers for PBCH with a subcarrier spacing of 15 kHz can be 180 to 190. For the defined frequency band, it should be satisfied at the same time that the frequency domain starting location of the SSB is taken as the start point, and the number of subcarriers including all PSS/SSS is 192. In this case, the maximum effective frequency band of the PBCH should be greater than 2.85 MHz. For a specific system supporting 3 MHz to 5 MHz, the time-frequency domain locations for transmitting SSB are shown in Table 18 below.

TABLE 18

| Channel | OFDM symbol index l | Subcarrier index k |
|---|---|---|
| or | relative to the start of | relative to the start of |
| signal | an SS/PBCH block | an SS/PBCH block |
| PSS | 0 | 56, 57, . . . , 182 |
| SSS | 2 | 56, 57, . . . , 182 |
| Set to 0 | 0 | 0, 1, . . . , 55, 183, 184, . . . , 191 |
| | 2 | 48, 49, . . . , 55, 183, 184, . . . , 191 |
| PBCH | 1, 3 | 0, 1, . . . , 191 |
| | 2 | 0, 1, . . . , 47, |
| DM-RS | 1, 3 | 0 + v, 4 + v, . . . , 188 + v |
| for PBCH | 2 | 0 + v, 4 + v, . . . , 44 + v |

Optionally, since the band guard interval has been considered when calculating the available bandwidth of the system, the upper guard band of PSS/SSS may not be included for PBCH truncation in frequency domain, so that the inter-band interference caused by excessive occupation of the available bandwidth can be avoided. The number of subcarriers from the frequency domain start point of the SSB to the PSS/SSS is 183. In this case, for a specific system supporting 3 MHz to 5 MHz, the time-frequency domain locations for transmitting SSB are shown in Table 19 below.

TABLE 19

| Channel | OFDM symbol index l | Subcarrier index k |
|---|---|---|
| or | relative to the start of | relative to the start of |
| signal | an SS/PBCH block | an SS/PBCH block |
| PSS | 0 | 56, 57, . . . , 182 |
| SSS | 2 | 56, 57, . . . , 182 |
| Set to 0 | 0 | 0, 1, . . . , 55 |
| | 2 | 48, 49, . . . , 55, |
| PBCH | 1, 3 | 0, 1, . . . , 182 |
| | 2 | 0, 1, . . . , 47, |
| DM-RS | 1, 3 | 0 + v, 4 + v, . . . , 178 + v |
| for PBCH | 2 | 0 + v, 4 + v, . . . , 44 + v |

Sub-method 3: The PBCH frequency domain is truncated according to the frequency domain location of Point A. Point A may be used to truncate the SSB when the frequency domain location of Point A overlaps with that of the SSB. In this method, the frequency domain location of Point A is determined by the base station, and the defined SSB bandwidth is determined by the effective frequency band supported by the system. This method can provide more freedom for the base station configuration, and the base station can truncate the PBCH according to the relative location of the SSB and Point A in frequency domain, and transmit the SSB. In this case, the time-frequency domain location for transmitting the SSB is shown in Table 20 below.

TABLE 20

| Channel | OFDM symbol index l | Subcarrier index k |
|---|---|---|
| or | relative to the start of | relative to the start |
| signal | an SS/PBCH block | of an SS/PBCH block |
| PSS | 0 | 56, 57, . . . , 182 |
| SSS | 2 | 56, 57, . . . , 182 |
| Set to 0 | 0 | If X < 55: X, . . . , 55, |
| | | If X = 55: X |
| | | If Y > 183: 183, . . . Y |
| | | If Y = 183: Y |
| | 2 | If X <= 48: 48, 49, ~, 55 |
| | | If 48 < X < 55: X, . . . , 55 |
| | | If X = 55: X |
| | | If Y >= 191: 183, 184, . . . , 191 |
| | | If 183 < Y < 191: 183, . . . , Y |
| | | If Y = 183: Y |
| PBCH | 1, 3 | X, . . . , Y |
| | 2 | If X < 47: X, . . . , 47, |
| | | If X = 47: X |
| | | If Y > 192: 192, . . . , Y |
| | | If Y = 192: Y |
| DM-RS | 1, 3 | X + v, . . . , Y + v |
| for PBCH | 2 | If X < 44: X + v, . . . , 44 + v |
| | | If X = 44: X + v |
| | | If Y > 192: 192 + v, . . . , Y + v |
| | | If Y = 192: Y + v |

Where the value range of X is 0 . . . 56, the value range of Y is 182 . . . 239, and Y-X should be smaller than or equal to the number of subcarriers in the effective bandwidth, such as 180 or 190. And considering the PBCH DMRS offset, the values of X and Y should be multiple of 4.

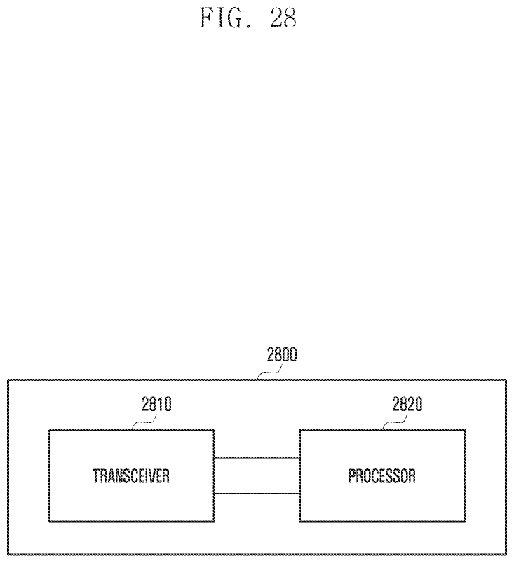

FIG. 28 is a block diagram illustrating the structure of a UE according to an embodiment of the present disclosure. Referring to FIG. 28, the terminal 2800 includes a transceiver 2810 and a processor 2820. The transceiver 2810 is configured to transmit and receive signals. The processor 2820 is configured to control the transceiver 2810 to perform various methods of the present disclosure.

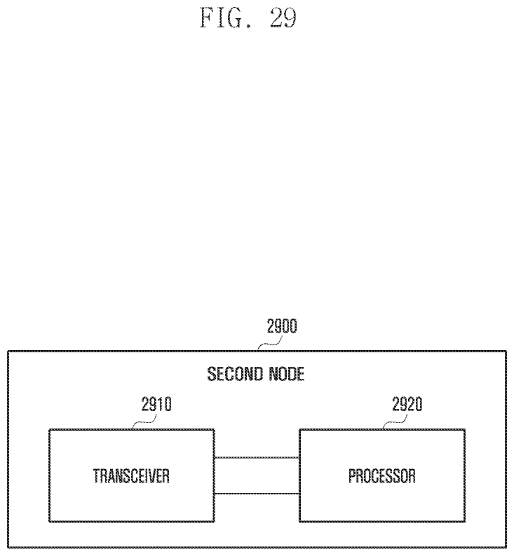

FIG. 29 is a block diagram illustrating the structure of a base station according to an embodiment of the present disclosure. Referring to FIG. 29, the base station 2900 includes a transceiver 2910 and a processor 2920. The transceiver 2910 is configured to transmit and receive signals. The processor 2920 is configured to control the transceiver 2910 to perform various methods of the present disclosure.

According to an aspect of the present disclosure, there is provided a method performed by a user equipment (UE) in a wireless communication system, including: determining a first subcarrier spacing for a base station to transmit a synchronization signal and physical broadcast channel block (SSB) to the UE; determining whether a frequency domain bandwidth of the SSB corresponding to the first subcarrier spacing exceeds a maximum transmission bandwidth available for receiving the SSB under bandwidth capability of the UE; receiving the SSB by performing a first operation in case that the frequency domain bandwidth of the SSB corresponding to the first subcarrier spacing does not exceed the maximum transmission bandwidth available for receiving the SSB under the bandwidth capability of the UE; and receiving the SSB by performing a second operation in case that the frequency domain bandwidth of the SSB corresponding to the first subcarrier spacing exceeds the maximum transmission bandwidth available for receiving the SSB under the bandwidth capability of the UE, wherein the first operation is different from the second operation.

Optionally, the step of determining the first subcarrier spacing for the base station to transmit the SSB to the UE includes: determining a frequency band for the base station to transmit the SSB to the UE; determining one or more subcarrier spacings corresponding to the frequency band based on a predetermined rule; and determining a second subcarrier spacing as the first subcarrier spacing in case that the determined one or more subcarrier spacings only include the second subcarrier spacing; determining a third subcarrier spacing as the first subcarrier spacing in case that the determined subcarrier spacings only include the third subcarrier spacing; determining the second subcarrier spacing as the first subcarrier spacing in case that the determined subcarrier spacings include the second subcarrier spacing and the third subcarrier spacing, wherein the second subcarrier spacing is smaller than the third subcarrier spacing, and a frequency domain bandwidth of the SSB corresponding to the second subcarrier spacing does not exceed the maximum transmission bandwidth available for receiving the SSB under the bandwidth capability of the UE, while a frequency domain bandwidth of the SSB corresponding to the third subcarrier spacing exceeds the maximum transmission bandwidth available for receiving the SSB under the bandwidth capability of the UE.

Optionally, the step of determining the first subcarrier spacing for the base station to transmit the SSB to the UE includes: determining the first subcarrier spacing for the base station to transmit the SSB to the UE through blind detection.

Optionally, the step of receiving the SSB by performing the second operation includes: determining whether a channel condition of the UE meets a predetermined condition; in case that the channel condition of the UE do not meet the predetermined conditions, giving up receiving, by the UE, the SSB; and in case that the channel condition of the UE meets the predetermined condition, receiving, by the UE, the SSB based on the first subcarrier spacing.

Optionally, the step of receiving the SSB by performing the second operation includes: receiving, by the UE, the SSB based on the first subcarrier spacing by expanding bandwidth capability.

Optionally, the UE expanding the bandwidth capability includes: increasing the maximum transmission bandwidth available for receiving the SSB under the bandwidth capability of the UE.

Optionally, the step of receiving the SSB by performing the second operation includes: receiving, by the UE, the SSB based on the first subcarrier spacing by offsetting a radio-frequency central frequency point.

Optionally, the step of receiving the SSB by performing the second operation includes: receiving, by the UE, the SSB and an auxiliary demodulation signal based on the first subcarrier spacing, wherein the auxiliary demodulation signal is used to demodulate resource elements in the SSB that exceed the maximum transmission bandwidth available for receiving the SSB under the bandwidth capability of the UE.

Optionally, one SSB occupies four time-domain symbols, and the auxiliary demodulation signal occupies two time-domain symbols immediately adjacent to the SSB, and wherein the auxiliary demodulation signal includes all or a part of resource elements (REs) in the frequency domain bandwidth of the SSB that exceed the bandwidth capability of the UE.

Optionally, one SSB occupies four time-domain symbols, and the auxiliary demodulation signal occupies one time-domain symbol immediately adjacent to the SSB, and wherein the auxiliary demodulation signal includes a part of resource elements (REs) in the frequency domain bandwidth of the SSB that exceed the bandwidth capability of the UE.

Optionally, the auxiliary demodulation signal includes REs, the number of which is an integer multiple of 4, truncated from a physical broadcast channel block (PBCH) of the SSB with reference to a frequency domain location of a primary synchronization signal (PSS)/secondary synchronization signal (SSS) of the SSB.

Optionally, the method includes: in case that the frequency domain bandwidth of the SSB corresponding to the first subcarrier spacing exceeds the maximum transmission bandwidth available for receiving the SSB under the bandwidth capability of the UE, the UE gives up receiving the SSB.

According to another aspect of the present disclosure, there is provided a method performed by a base station in a wireless communication system, including: determining a first subcarrier spacing for transmitting a synchronization signal and physical broadcast channel block (SSB) to a user equipment (UE); determining whether a frequency domain bandwidth of the SSB corresponding to the first subcarrier spacing exceeds a maximum transmission bandwidth available for receiving the SSB under bandwidth capability of the UE; transmitting the SSB by performing a first operation in case that the frequency domain bandwidth of the SSB corresponding to the first subcarrier spacing does not exceed the maximum transmission bandwidth available for receiving the SSB under the bandwidth capability of the UE; and transmitting the SSB by performing a second operation in case that the frequency domain bandwidth of the SSB corresponding to the first subcarrier spacing exceeds the maximum transmission bandwidth available for receiving the SSB under the bandwidth capability of the UE, wherein the first operation is different from the second operation.

Optionally, the step of determining the first subcarrier spacing for transmitting the SSB to the UE includes: determining a frequency band for transmitting the synchronization signal and physical broadcast channel block (SSB) to the UE; determining one or more subcarrier spacings corresponding to the frequency band based on a predetermined rule; and determining a second subcarrier spacing as the first subcarrier spacing in case that the determined one or more subcarrier spacings only include the second subcarrier spacing; determining a third subcarrier spacing as the first subcarrier spacing in case that the determined one or more subcarrier spacings only include the third subcarrier spacing; determining the second subcarrier spacing as the first subcarrier spacing in case that the determined one or more subcarrier spacings include the second subcarrier spacing and the third subcarrier, wherein the second subcarrier spacing is smaller than the third subcarrier spacing, and a frequency domain bandwidth of the SSB corresponding to the second subcarrier spacing does not exceed the maximum transmission bandwidth available for receiving the SSB under the bandwidth capability of the UE, while a frequency domain bandwidth of the SSB corresponding to the third subcarrier spacing exceeds the maximum transmission bandwidth available for receiving the SSB under the bandwidth capability of the UE.

Optionally, the step of transmitting the SSB by performing the second operation includes: transmitting the SSB and an auxiliary demodulation signal based on the first subcarrier spacing, wherein the auxiliary demodulation signal is used by the UE to demodulate resource elements in the SSB that exceed the maximum transmission bandwidth available for transmitting the SSB under the bandwidth capability of the UE.

Optionally, one SSB occupies four time-domain symbols, and the auxiliary demodulation signal occupies two time-domain symbols immediately adjacent to the SSB, and wherein the auxiliary demodulation signal includes all or part of resource elements (REs) in the frequency domain bandwidth of the SSB that exceed the bandwidth capability of the UE.

Optionally, one SSB occupies four time-domain symbols, and the auxiliary demodulation signal occupies one time-domain symbol immediately adjacent to the SSB, and wherein the auxiliary demodulation signal includes a part of resource elements (REs) in the frequency domain bandwidth of the SSB that exceed the bandwidth capability of the UE.

Optionally, the auxiliary demodulation signal includes REs, the number of which is an integer multiple of 4, truncated from a physical broadcast channel block (PBCH) of the SSB with reference to a frequency domain location of a primary synchronization signal (PSS)/secondary synchronization signal (SSS) of the SSB.

According to yet another aspect of the present disclosure, there is provided a user equipment (UE) in a wireless communication network, including a transceiver configured to transmit and receive signals; and a controller configured to control the transceiver to perform: determining a first subcarrier spacing for a base station to transmit a synchronization signal and physical broadcast channel block (SSB) to the UE; determining whether a frequency domain bandwidth of the SSB corresponding to the first subcarrier spacing exceeds a maximum transmission bandwidth available for receiving the SSB under bandwidth capability of the UE; receiving the SSB by performing a first operation in case that the frequency domain bandwidth of the SSB corresponding to the first subcarrier spacing does not exceed the maximum transmission bandwidth available for receiving the SSB under the bandwidth capability of the UE; and receiving the SSB by performing a second operation in case that the frequency domain bandwidth of the SSB corresponding to the first subcarrier spacing exceeds the maximum transmission bandwidth available for receiving the SSB under the bandwidth capability of the UE, wherein the first operation is different from the second operation.

According to yet another aspect of the present disclosure, there is provided a base station in a wireless communication network, including a transceiver configured to transmit and receive signals; and a controller configured to control the transceiver to perform: determining a first subcarrier spacing for transmitting a synchronization signal and physical broadcast channel block (SSB) to a user equipment (UE); determining whether a frequency domain bandwidth of the SSB corresponding to the first subcarrier spacing exceeds a maximum transmission bandwidth available for receiving the SSB under bandwidth capability of the UE; transmitting the SSB by performing a first operation in case that the frequency domain bandwidth of the SSB corresponding to the first subcarrier spacing does not exceed the maximum transmission bandwidth available for receiving the SSB under the bandwidth capability of the UE; and transmitting the SSB by performing a second operation in case that the frequency domain bandwidth of the SSB corresponding to the first subcarrier spacing exceeds the maximum transmission bandwidth available for receiving the SSB under the bandwidth capability of the UE, wherein the first operation is different from the second operation.

According to yet another aspect of the present disclosure, there is provided a method performed by a user equipment (UE) in a wireless communication system, including: receiving a primary synchronization signal (PSS) and a secondary synchronization signal (SSS); receiving a physical broadcast channel block (PBCH); wherein the primary synchronization signal, the secondary synchronization signal and the PBCH constitute a synchronization signal and PBCH block (SSB).

Optionally, the user equipment (UE) determines a frequency domain location of the SSB on a predetermined frequency band, and receives a part of frequency domain resources of the SSB according to the predetermined frequency band and the frequency domain location of the SSB.

Optionally, the part of frequency domain resources of the SSB include all frequency domain resources of the PSS/SSS and a part of frequency domain resources of the PBCH.

Optionally, the SSB is received on a predetermined frequency band according to at least two subcarrier spacings.

Optionally, SSB reception with a bandwidth of 5 MHz is performed on a predetermined frequency band according to a predetermined subcarrier spacing.

Optionally, the predetermined frequency band includes at least one of n77, n78, n79, railway mobile radio (RMR)-900 frequency band, n8, n26 and n28.

Optionally, receiving the PBCH includes: receiving the PBCH according to a first PBCH frequency domain location and a second PBCH frequency domain location.

Optionally, the start point of the second PBCH frequency domain location is different from the start point of the first PBCH frequency domain location, and the number of subcarriers in the second PBCH frequency domain location is different from the number of subcarriers in the first PBCH frequency domain location.

Optionally, if the UE is a first type UE, a location of a first time unit of the SSB is a first location; and if the UE is a second type UE, the location of the first time unit of the SSB is a second location.

According to yet another aspect of the present disclosure, there is provided a method performed by a base station in a wireless communication system, including: transmitting a primary synchronization signal (PSS) and a secondary synchronization signal (SSS); transmitting a physical broadcast channel block (PBCH), wherein the primary synchronization signal, the secondary synchronization signal and the PBCH constitute a synchronization signal and PBCH block (SSB).

Optionally, the base station transmits a part of frequency domain resources of the SSB on a predetermined frequency band.

Optionally, the part of frequency domain resources of the SSB includes all frequency domain resources of the PSS/SSS and a part of frequency domain resources of the PBCH.

Optionally, the SSB is transmitted on a predetermined frequency band according to a first subcarrier spacing and a second subcarrier spacing.

Optionally, SSB transmission with a bandwidth of 5 MHz is performed on a predetermined frequency band according to a first subcarrier spacing and/or a second subcarrier spacing.

Optionally, the predetermined frequency band includes at least one of n77, n78, n79, railway mobile radio (RMR)-900 frequency band, n8, n26 and n28.

Optionally, transmitting the PBCH includes: transmitting the PBCH according to a first PBCH frequency domain location and a second PBCH frequency domain location.

Optionally, the start point of the second PBCH frequency domain location is different from the start point of the first PBCH frequency domain location, and the number of subcarriers in the second PBCH frequency domain location is different from the number of subcarriers in the first PBCH frequency domain location.

Optionally, if the UE is a first type UE, a location of a first time unit of the SSB is a first location; and if the UE is a second type UE, the location of the first time unit of the SSB is a second location.

According to yet another aspect of the present disclosure, there is provided a user equipment (UE) in a wireless communication network, including a transceiver configured to transmit and receive signals; and a controller configured to control the transceiver to perform: receiving a primary synchronization signal (PSS) and a secondary synchronization signal (SSS); receiving a physical broadcast channel block (PBCH); wherein the primary synchronization signal, the secondary synchronization signal and the PBCH constitute a synchronization signal and PBCH block (SSB).

According to yet another aspect of the present disclosure, there is provided a base station in a wireless communication network, including a transceiver configured to transmit and receive signals; and a controller configured to control the transceiver to perform: transmitting a primary synchronization signal (PSS) and a secondary synchronization signal (SSS); transmitting a physical broadcast channel block (PBCH), wherein the primary synchronization signal, the secondary synchronization signal and the PBCH constitute a synchronization signal and PBCH block (SSB).

Various embodiments of the present disclosure may be implemented as computer-readable codes embodied on a computer-readable recording medium from a specific perspective. The computer-readable recording medium may be a volatile computer-readable recording medium or a nonvolatile computer-readable recording medium. A computer-readable recording medium is any data storage device that can store data readable by a computer system. Examples of computer-readable recording media may include read-only memory (ROM), random access memory (RAM), compact disk read-only memory (CD-ROM), magnetic tape, floppy disk, optical data storage device, carrier wave (e.g., data transmission via the Internet), etc. Computer-readable recording media can be distributed by computer systems connected via a network, and thus computer-readable codes can be stored and executed in a distributed manner. Furthermore, functional programs, codes and code segments for implementing various embodiments of the present disclosure can be easily explained by those skilled in the art to which the embodiments of the present disclosure are applied.

It will be understood that the embodiments of the present disclosure may be implemented in the form of hardware, software, or a combination of hardware and software. The software may be stored as program instructions or computer-readable codes executable on a processor on a non-transitory computer-readable medium. Examples of non-transitory computer-readable recording media include magnetic storage media (such as ROM, floppy disk, hard disk, etc.) and optical recording media (such as CD-ROM, digital video disk (DVD), etc.). Non-transitory computer-readable recording media may also be distributed on computer systems coupled to a network, so that computer-readable codes are stored and executed in a distributed manner. The medium can be read by a computer, stored in a memory, and executed by a processor. Various embodiments may be implemented by a computer or a portable terminal including a controller and a memory, and the memory may be an example of a non-transitory computer-readable recording medium suitable for storing program(s) with instructions for implementing embodiments of the present disclosure. The present disclosure may be realized by a program with code for concretely implementing the apparatus and method described in the claims, which is stored in a machine (or computer)-readable storage medium. The program may be electronically carried on any medium, such as a communication signal transmitted via a wired or wireless connection, and the present disclosure suitably includes its equivalents.

What has been described above is only the specific implementation of the present disclosure, but the scope of protection of the present disclosure is not limited thereto. Anyone who is familiar with this technical field may make various changes or substitutions within the technical scope disclosed in the present disclosure, and these changes or substitutions should be covered within the scope of protection of the present disclosure. Therefore, the scope of protection of the present disclosure should be based on the scope of protection of the claims.

1.-15. (canceled)

16. A method performed by a reduced capability user equipment (Redcap UE) in a wireless communication system, the method comprising:
receiving, from a base station, a master information block (MIB) including resource allocation information for control resource set (CORESET) #0;
receiving, from the base station, a configuration for initial downlink bandwidth part (DL BWP) for the Redcap UE; and
in case that the initial DL BWP does not contain the CORESET #0, configuring a first common search space for random access (RA) based on the initial DL BWP, and configuring a second common search space for paging and system information based on the CORESET #0.

17. The method of claim 16, wherein the configuration for initial DL BWP is received in a radio resource control (RRC) message.

18. The method of claim 16, wherein the configuration for initial DL BWP does not include search space for paging.

19. The method of claim 16, wherein the configuration for initial DL BWP does not include search space for other system information.

20. The method of claim 16, further comprising:
in case that a bwp-inactivity timer associated with an active DL BWP expires, performing BWP switching based on the configuration for initial DL BWP for the Redcap UE.

21. The method of claim 16, further comprising:
in case that a physical random access channel (PRACH) occasions are not configured for an active uplink (UL) BWP; switching the active UL BWP to a BWP indicated by the configuration for initial DL BWP for the Redcap UE.

22. A reduced capability user equipment (Redcap UE) in a wireless communication system, the Redcap UE comprising:
a transceiver; and
a controller configured to:
receive, from a base station via the transceiver, a master information block (MIB) including resource allocation information for control resource set (CORESET) #0,
receive, from the base station via the transceiver, a configuration for initial downlink bandwidth part (DL BWP) for the Redcap UE, and
in case that the initial DL BWP does not contain the CORESET #0, configure a first common search space for random access (RA) based on the initial DL BWP, and configure a second common search space for paging and system information based on the CORESET #0.

23. The Redcap UE of claim 22, wherein the configuration for initial DL BWP is received in a radio resource control (RRC) message.

24. The Redcap UE of claim 22, wherein the configuration for initial DL BWP does not include search space for paging.

25. The Redcap UE of claim 22, wherein the configuration for initial DL BWP does not include search space for other system information.

26. The Redcap UE of claim 22, wherein the controller is further configured to:
in case that a bwp-inactivity timer associated with an active DL BWP expires, perform BWP switching based on the configuration for initial DL BWP for the Redcap UE.

27. The Redcap UE of claim 22, wherein the controller is further configured to:
in case that a physical random access channel (PRACH) occasions are not configured for an active uplink (UL) BWP; switch the active UL BWP to a BWP indicated by the configuration for initial DL BWP for the Redcap UE.
